(19) United States
(12) Patent Application Publication
(10) Pub. No.: US 2026/0145644 A1
(43) Pub. Date: May 28, 2026

(54) VEHICLE COLLABORATION TO DETER SUSPICIOUS ACTIVITY

(71) Applicant: TOYOTA MOTOR ENGINEERING & MANUFACTURING NORTH AMERICA, INC., PLANO, TX (US)

(72) Inventors: SEYHAN UCAR, Mountain View, CA (US); CAN CUI, Mountain View, CA (US); YONGKANG LIU, Mountain View, CA (US); AHMADREZA MORADIPARI, Mountain View, CA (US); EMRAH AKIN SISBOT, Mountain View, CA (US); KENTARO OGUCHI, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, Toyota-shi (JP)

(21) Appl. No.: 19/175,499

(22) Filed: Apr. 10, 2025

Related U.S. Application Data
(63) Continuation-in-part of application No. 18/956,340, filed on Nov. 22, 2024.

(51) Int. Cl. B60R 25/31; B60R 25/10; G05D 1/69; G05D 105/85; G05D 109/10; G06F 40/20

(52) U.S. Cl. CPC B60R 25/31; B60R 25/10; G05D 1/69; G06F 40/20; B60R 2025/1013; B60R 2325/30; G05D 2105/85; G05D 2109/10

(57) ABSTRACT

Systems and methods are provided for deterring suspicious activity in relation to vehicles through collaboration among the vehicles. Such systems and methods may involve intelligent assignment of sub-tasks of a collaborative deterrence strategy to a group of the vehicles based on resource and capability profiles of the group of vehicles. For example, the group of vehicles may be assigned specific sub-tasks based on at least one of: (i) differences in sensor resources across the group of vehicles; (ii) differences in processing resources across the group of vehicles; (iii) differences in wireless communication resources across the group of vehicles; (iv) differences in audio-visual output capabilities across the group of vehicles; or (v) differences in autonomous driving capabilities across the group of vehicles.

### CROSS-REFERENCE TO RELATED APPLICATIONS

This application is a continuation-in-part of and claims the benefit of U.S. patent application Ser. No. 18/956,340 filed on Nov. 22, 2024, and is related to co-pending and co-owned U.S. patent application Ser. No. ______, filed on even date herewith, titled “DETECTING AND DETERRING SUSPICIOUS ACTIVITY IN RELATION TO VEHICLES,” which are hereby incorporated herein by reference in their entirety for all purposes.

### TECHNICAL FIELD

The present disclosure relates generally to vehicle security, and more particularly, some aspects relate to facilitating collaboration among vehicles to monitor and deter suspicious activity.

### DESCRIPTION OF RELATED ART

Suspicious activity can be any undesirable behavior occurring in the surrounding environment or in proximity to a subject vehicle. Suspicious activity can occur relative to the physical/operating aspects or characteristics of the subject vehicle, as well as the user/owner of the subject vehicle. In some embodiments, suspicious activity may include any activity that could indicate a person may be involved in a crime or about to commit a crime. Related behaviors can include, but are not limited to, smashing car windows and taking valuable personal items, lifting the vehicle to grab valuable parts of the vehicle, or any other actions affecting or related to the subject vehicle.

Vehicles have deterrents such as video recording, audible alarms, or visual devices such as wheel locks in an effort to detect suspicious activity and to prevent harmful activities such as vehicle tampering or vehicle theft. However, vehicles are still vulnerable, and these deterrents are often inadequate. According to the National Insurance Crime Bureau, there was a 325% increase in catalytic converter theft in 2020.

### BRIEF SUMMARY OF THE DISCLOSURE

According to various embodiments of the disclosed technology a method is provided. The method may comprise: (1) responsive to detecting suspicious activity being perpetrated by one or more individuals in relation to vehicles, determining a collaborative strategy to deter the suspicious activity; (2) assigning sub-tasks of the collaborative deterrence strategy to a group of the vehicles based on resource and capability profiles of the group of vehicles; and (3) controlling at least one of the group of vehicles to perform its assigned sub-task of the collaborative deterrence strategy.

In some embodiments of the method, the assigning can based on at least one of: (a) differences in sensor resources across the group of vehicles; (b) differences in processing resources across the group of vehicles; (c) differences in wireless communication resources across the group of vehicles; (d) differences in audio-visual output capabilities across the group of vehicles; or (e) differences in autonomous driving capabilities across the group of vehicles.

For example, the group of vehicles may comprises at least a first vehicle and a second vehicle and assigning the sub-tasks of the collaborative deterrence strategy to the first and second vehicles may comprise: (i) determining the first vehicle has superior processing resources to the second vehicle; (ii) assigning the first vehicle to further analyze the activity of the one or more individuals in relation to the vehicles; and (iii) assigning the second vehicle to perform a less processor-intensive sub-task of the collaborative deterrence strategy. As second example, assigning the sub-tasks of the collaborative deterrence strategy to the first and second vehicles may comprise: (i) determining the first vehicle has superior audio output capabilities to the second vehicle; (ii) assigning the first vehicle to output an audio-based deterrence action; and (iii) assigning the second vehicle to perform a non-audio output-related sub-task of the collaborative deterrence strategy. As a third example, assigning the sub-tasks of the collaborative deterrence strategy to the first and second vehicles may comprise: (i) determining the first vehicle has a superior visual display to the second vehicle; (ii) assigning the first vehicle to display video of the one or more individuals on its superior visual display; and (iii) assigning the second vehicle to perform a non-visual output-related sub-task of the collaborative deterrence strategy. As a fourth example, assigning the sub-tasks of the collaborative deterrence strategy to the first and second vehicles may comprise: (i) determining the first vehicle has superior autonomous driving capabilities to the second vehicle; (ii) assigning the first vehicle to move autonomously to deter the suspicious activity; and (iii) assigning the second vehicle to perform a non-autonomous driving-related sub-task of the collaborative deterrence strategy.

In certain embodiments of the method, the assigning may be further based on positional relationships between the one or more individuals and respective vehicles of the group of vehicles. For example, assigning the sub-tasks of the collaborative deterrence strategy to the first and second vehicles may comprise: (i) determining that at least one of the one or more individuals is gazing into the first vehicle; (ii) assigning the first vehicle to display video of the one or more individuals on a visual display within the first vehicle; and (iii) assigning the second vehicle to perform a non-visual output-related sub-task of the collaborative deterrence strategy.

In various embodiments of the method, the method may further comprise, responsive to detecting the suspicious activity being perpetrated by the one or more individuals in relation to the vehicles: (a) determining a collaborative strategy to monitor the suspicious activity; and (b) assigning sub-tasks of the collaborative monitoring strategy to the group of vehicles based on: (i) the resource and capability profiles of the group of vehicles, and (ii) positional relationships between the one or more individuals and respective vehicles of the group of vehicles. Here, assigning the sub-tasks of the collaborative monitoring strategy can be based on at least one of: (A) differences in audio-recording resources and audio-recording capabilities across the group of vehicles; (B) differences in video-recording resources and video-recording capabilities across the group of vehicles; or (C) differences in motion tracking resources and motion tracking capabilities across the group of vehicles.

In some embodiments of the method, detecting the suspicious activity being perpetrated by the one or more individuals in relation to the vehicles may comprise: (a) obtaining video of the one or more individuals; (b) generating, from the video, natural language descriptions for physical characteristics of the one or more individuals and movement characteristics of the one or more individuals relative to the vehicles; and (c) providing the generated natural language descriptions to a natural language processing (NPL) model and using the NPL model to determine the one or more individuals are acting suspiciously in relation to the vehicles.

According to various embodiments of the disclosed technology a system is provided. The system may comprise: (1) one or more processors; and (2) memory storing machine-readable instructions that, when executed by the one or more processors, cause the system to: (a) responsive to detecting suspicious activity being perpetrated by an individual in relation to vehicles, determine a collaborative strategy to deter the suspicious activity; (b) assign sub-tasks of the collaborative deterrence strategy to a group of the vehicles based on at least one of: resource and capability profiles of the group of vehicles, or positional relationships between the individual and respective vehicles of the group of vehicles, and (c) control at least one of the group of vehicles to perform its assigned sub-task of the collaborative deterrence strategy.

In some embodiments of the system, the assigning based on the positional relationships between the individual and the respective vehicles may be based on detected location and attentional direction of the individual with respect to the respective vehicles. For example, the group of vehicles may comprise at least a first vehicle and a second vehicle and assigning the sub-tasks of the collaborative deterrence strategy to the first and second vehicles may comprise: (i) determining the individual is gazing into the first vehicle; (ii) assigning the first vehicle to display video of the individual on a visual display within the first vehicle; and (iii) assigning the second vehicle to perform a non-visual output-related sub-task of the collaborative deterrence strategy.

In certain embodiments of the system, the assigning based on the resource and capability profiles of the group of vehicles may be based on at least one of: (i) differences in sensor resources across the group of vehicles; (ii) differences in processing resources across the group of vehicles; (iii) differences in wireless communication resources across the group of vehicles; (iv) differences in audio-visual output capabilities across the group of vehicles; or (v) differences in autonomous driving capabilities across the group of vehicles. For example, assigning the sub-tasks of the collaborative deterrence strategy to the first and second vehicles may comprise: (A) determining the first vehicle has superior processing resources to the second vehicle; (B) assigning the first vehicle to further analyze the activity of the individual in relation to the vehicles; and (C) assigning the second vehicle to perform a less processor-intensive sub-task of the collaborative deterrence strategy. As a second example, assigning the sub-tasks of the collaborative deterrence strategy to the first and second vehicles may comprise: (A) determining the first vehicle has superior audio output capabilities to the second vehicle; (B) assigning the first vehicle to output an audio-based deterrence action; and (C) assigning the second vehicle to perform a non-audio output-related sub-task of the collaborative deterrence strategy. As a third example, assigning the sub-tasks of the collaborative deterrence strategy to the first and second vehicles may comprise: (A) determining the first vehicle has a superior visual display to the second vehicle; (B) assigning the first vehicle to display video of the individual on its superior visual display; and (C) assigning the second vehicle to perform a non-visual output-related sub-task of the collaborative deterrence strategy. As a fourth example, assigning the sub-tasks of the collaborative deterrence strategy to the first and second vehicles may comprise: (A) determining the first vehicle has superior autonomous driving capabilities to the second vehicle; (B) assigning the first vehicle to move autonomously to deter the suspicious activity; and (C) assigning the second vehicle to perform a non-autonomous driving-related sub-task of the collaborative deterrence strategy.

According to various embodiments of the disclosed technology a second method is provided. The second method may comprise: (1) responsive detecting suspicious activity being perpetrated by an individual in relation to vehicles, determining a collaborative strategy to deter the suspicious activity; (2) assigning sub-tasks of the collaborative deterrence strategy to a group of the vehicles based on at least one of: resource and capability profiles of the group of vehicles, or positional relationships between the individual and respective vehicles of the group of vehicles, and (3) controlling at least one of the group of vehicles to perform its assigned sub-task of the collaborative deterrence strategy.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example of an all-wheel drive hybrid vehicle with which embodiments of the systems and methods disclosed herein may be implemented.

FIG. 3A illustrates an example architecture for detecting a potential threat in a vicinity of an ego vehicle and performing a deterrence action in response to the detection, in accordance with one embodiment of the systems and methods described herein.

FIG. 3B illustrates an example implementation of a storage system, in accordance with one embodiment of the systems and methods described herein.

FIGS. 4-8 illustrate example implementations of detecting a potential threat in a vicinity of an ego vehicle and performing a deterrence action in response to the detection, in accordance with some embodiments of the systems and methods described herein, which may be implemented in conjunction with the example architecture illustrated in FIG. 3A. In FIG. 8, one or more neighboring vehicles are deployed to perform a deterrence action.

FIG. 9 is a flowchart summarizing the steps of detecting a potential threat in a vicinity of an ego vehicle and performing a deterrence action in response to the detection.

FIG. 10 is a flowchart summarizing the steps of detecting a potential threat in a vicinity of an ego vehicle and deploying one or more neighboring vehicles to perform a deterrence action in response to the detection.

FIG. 11 illustrates an example implementation of a collaborative deterrence system, in accordance with various embodiments of the presently disclosed technology.

FIG. 12 illustrates an example method that may be performed by a collaborative deterrence system to deter suspicious activity in relation to vehicles, in accordance with various embodiments of the presently disclosed technology.

FIG. 13 illustrates an example natural language processing-based method that may be performed by a monitoring and deterrence system to determine individuals are acting suspiciously in relation to vehicles, in accordance with various embodiments of the presently disclosed technology.

FIG. 14 depicts a first example collaborative deterrence strategy, in accordance with various embodiments of the presently disclosed technology.

FIG. 15 depicts a second example collaborative deterrence strategy, in accordance with various embodiments of the presently disclosed technology.

FIG. 16 depicts a third example collaborative deterrence strategy, in accordance with various embodiments of the presently disclosed technology.

FIG. 17 depicts a fourth example collaborative deterrence strategy, in accordance with various embodiments of the presently disclosed technology.

FIG. 18 depicts a fifth example collaborative deterrence strategy, in accordance with various embodiments of the presently disclosed technology.

FIG. 19 is an example computing component that may be used to implement various features of embodiments described in the present disclosure.

The figures are not exhaustive and do not limit the present disclosure to the precise form disclosed.

### DETAILED DESCRIPTION

A deterrence system of an ego vehicle may be implemented to provide a proactive and intelligent approach to improve safety of the ego vehicle as well as for neighboring vehicles and surroundings. The deterrence system may obtain sensor data from one or more sensors. The sensor data may include characteristics of a potential threat, which may include a person, another vehicle, an animal, or other being or object. The characteristics may include navigation characteristics such as relative position, relative velocity, relative heading, and/or relative acceleration of the potential threat with respect to the ego vehicle. The characteristics may include sensory characteristics of the potential threat such as visual, audio, and/or olfactory characteristics. The sensory characteristics may include additional objects associated with the potential threat such as weapons. In some embodiments, the characteristics may be inferred if not directly obtained or measured. In some embodiments, the characteristics may be inferred using object detection and/or a neural network, such as a convolutional neural network (CNN) and transformer architecture. In some embodiments, the sensor data may include characteristics of the ego vehicle itself.

Based on an evaluation of the sensor data, the deterrence system may activate certain features or augment existing features such as media (e.g., video) recording features, upon detecting a potential threat. The deterrence system may infer a type, classification, or category (hereinafter “type”) of the potential threat, a degree of severity of the potential threat, or a probability that the potential threat is an actual threat based on the sensor data and/or any recorded data. Example types of the potential threat may include a person, an animal, another vehicle, or a structure such as a collapsing structure. The deterrence system determines and implements a deterrence action based on any one or any combination of the inferred type of the potential threat, the degree of severity of the potential threat, the probability that the potential threat is an actual threat, or the sensor data. In some embodiments, determining the deterrence action is based on a lookup table, an artificial intelligence (AI) component such as a generative AI component, or a machine learning component.

In some embodiments, the deterrence action includes outputting an alarm or an audio output. The alarm or audio output may be set at a fixed or varying volume, speed, frequency, and/or other characteristic. The audio output may include an indication of a navigation or sensory characteristic of the potential threat, a command, and/or a warning of a further deterrence action if the potential threat fails to comply with the command. One example of the audio output may include, “Person in the hoodie, move away from the vehicle and put down the weapon or else authorities will be called!” In some embodiments, the deterrence action may, additionally or alternatively, include a textual output.

In some embodiments, the deterrence action includes outputting a warning to one or more neighboring vehicles regarding the potential threat. For example, the ego vehicle may be part of a peer-to-peer network with other neighboring vehicles. An example of a peer-to-peer network is Vehicular Micro Cloud. The ego vehicle may communicate with the other neighboring vehicles via Vehicle-to-Vehicle (V2V) communications. The communication may be via a remote server over Vehicle-to-Network (V2N). The remote server may generate deterrence strategies and/or communicate with the neighboring vehicles. In some embodiments, the communication with the neighboring vehicles may include a request for assistance or an indication of the potential threat. For example, the neighboring vehicles may not have been able to detect the potential threat yet, but may be informed ahead of time regarding the potential threat. Likewise, the ego vehicle may also be configured to receive communications from one or more neighboring vehicles regarding a potential threat.

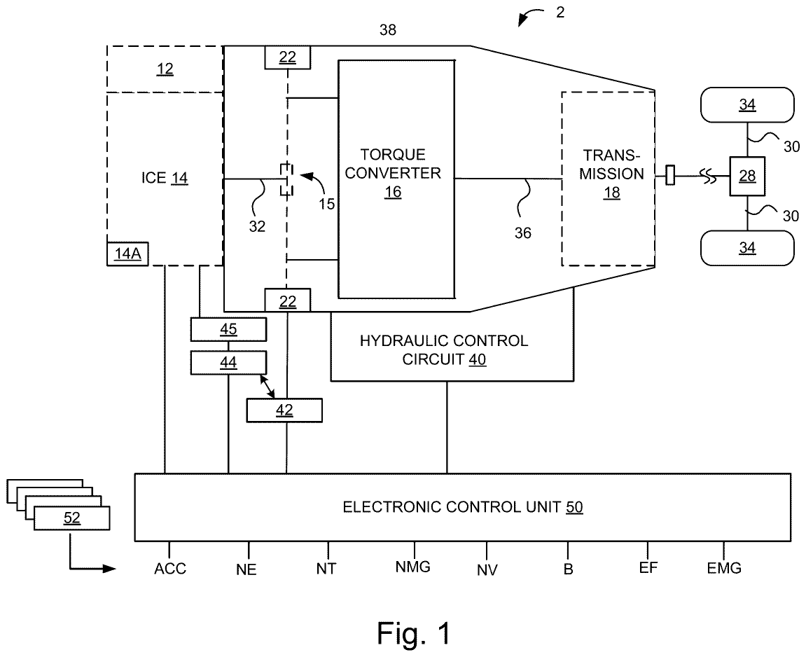

The systems and methods disclosed herein may be implemented with any of a number of different ego vehicles and ego vehicle types. For example, the systems and methods disclosed herein may be used with automobiles, trucks, motorcycles, recreational vehicles and other like on-or off-road vehicles. In addition, the principles disclosed herein may also extend to other vehicle types as well. An example hybrid electric vehicle (HEV) in which embodiments of the disclosed technology may be implemented as an ego vehicle and is illustrated in FIG. 1. Although the example described with reference to FIG. 1 is a hybrid type of ego vehicle, the systems and methods for driver fitness assessment can be implemented in other types of ego vehicles including gasoline- or diesel-powered vehicles, fuel-cell vehicles, electric vehicles, or other vehicles.

FIG. 1 illustrates a drive system of an ego vehicle 2 that may include an internal combustion engine 14 and one or more motors 22 (e.g., electric motors, which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, ego vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, ego vehicle 2 relies on the motive force generated at least by internal combustion engine 14, and a clutch 15 may be included to engage engine 14. In the EV travel mode, ego vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in ego vehicle 2 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit 40. When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, ego vehicle 2 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50 execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in ego vehicle 2. For example, electronic control unit 50 may receive signals that indicate ego vehicle operating conditions or characteristics, or signals that can be used to derive ego vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, ego vehicle 2 can include a plurality of sensors 52 that can be used to detect various conditions internal or external to the vehicle and provide sensed conditions to electronic control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14+cooling system 12) efficiency, acceleration, ACC, etc. In some embodiments, sensors 52 may detect navigation characteristics of the ego vehicle 2 or of a potential threat, such as another vehicle, pedestrian, animal, or other object. Here, navigation characteristics may include an absolute position, an absolute velocity, an absolute heading, or an absolute acceleration of the ego vehicle 2 or of the obstacle. The navigation characteristics may also include a relative position, a relative velocity, a relative heading, or a relative acceleration of the ego vehicle 2 with respect to the potential threat.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

As evident, sensors 52 may be included to detect not only vehicle conditions but also to detect external conditions, such as of the potential threat, as well. Sensors that might be used to detect external conditions can include, for example, sonar, radar, lidar or other vehicle proximity sensors, and cameras or other image sensors. Image sensors can be used to detect, for example, objects such as traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The sensors 52 may be within an interior or on an exterior of the ego vehicle 2. The sensors 52 may also include capturing sensors, which capture sensor data within the ego vehicle 2 or within surroundings of the ego vehicle 2. In some embodiments, additional sensors may not be directly connected to the ego vehicle 2, but rather, may be located on a different entity, such as a drone or a stationary landmark such as a traffic light.

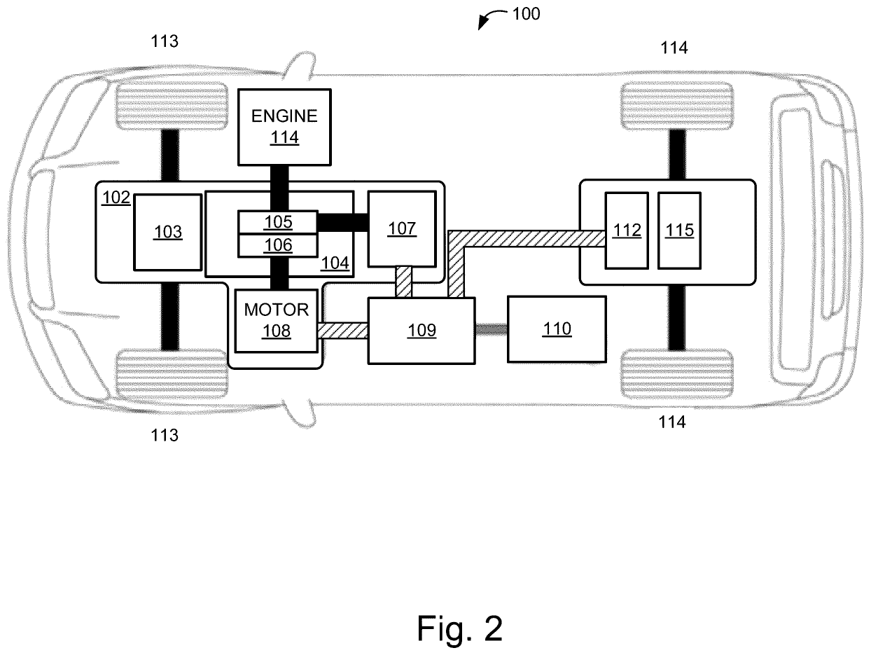

FIG. 2 is another example of an ego vehicle with which systems and methods for assessing occupant fitness can be implemented. The example illustrated in FIG. 2 is also that of a hybrid vehicle drive system of a vehicle 100 that may also include an engine 114 (e.g., internal combustion engine 14) and one or more electric motors 108, 112 (e.g., motors 22) as sources of motive power. In this example, a hybrid transaxle assembly 102 includes front differential 103, a compound gear unit 104, a motor 108, and a generator 107. Compound gear unit 104 includes a power split planetary gear unit 105 and a motor speed reduction planetary gear unit 106. This example vehicle also includes front and rear drive motors 108, 112, an inverter with converter assembly 109, battery 110 (which may include multiple batteries), and a rear differential 115. Hybrid transaxle assembly 102 enables power from engine 101, motor 108, or both to be applied to front wheels 113 via front differential 103.

Inverter with converter assembly 109 inverts DC power from battery 110 to create AC power to drive AC motors 108, 112. In embodiments where motors 108, 112 are DC motors, no inverter is required. Inverter with converter assembly 109 also accepts power from generator 107 (e.g., during engine charging) and uses this power to charge battery 110.

The examples of FIGS. 1 and 2 are provided for illustration purposes only as examples of vehicle systems with which embodiments of the disclosed technology may be implemented. One of ordinary skill in the art reading this description will understand how the disclosed embodiments can be implemented with vehicle platforms.

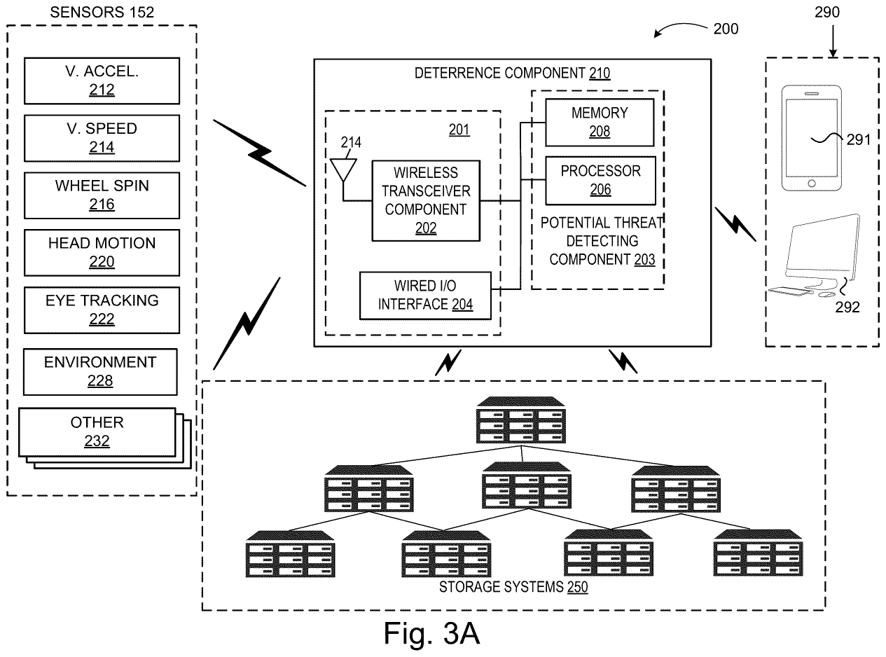

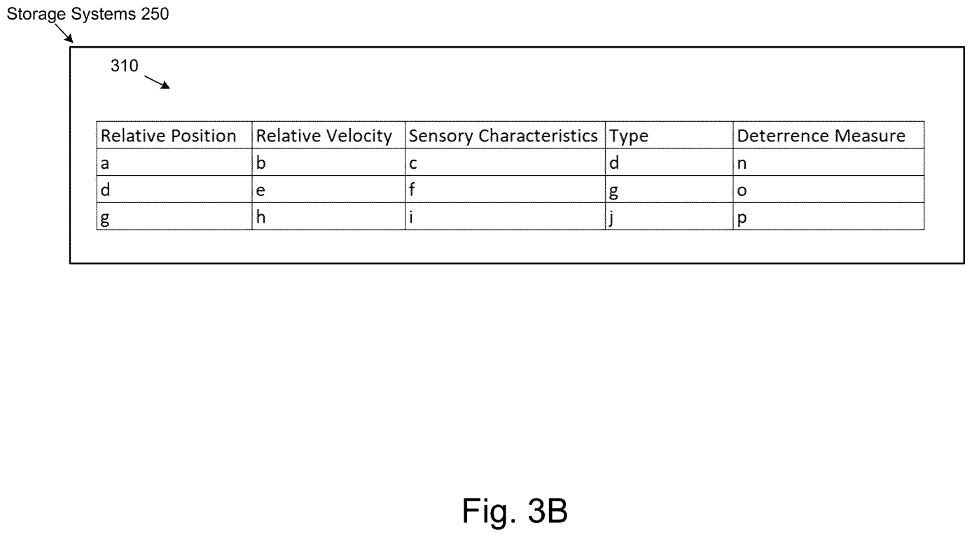

FIG. 3A illustrates an example architecture for adaptively and selectively implementing a deterrence action, based on sensor data detected at least in part by sensors 52 illustrated in FIG. 1, in accordance with one embodiment of the systems and methods described herein. Referring now to FIG. 3A, in this example, deterrence system 200 includes a deterrence component 210, which selectively activates or deactivates certain features of the ego vehicle 2, implements actions of the ego vehicle 2 or actions directed towards or controlling a potential threat, or other neighboring vehicle within a same network as the ego vehicle 2. These actions may include outputting an alarm or generating an audio output directed to the potential threat or a neighboring vehicle within a same network as the ego vehicle 2, to eliminate or mitigate the potential threat. Deterrence component 210 can be implemented as an ECU or as part of an ECU such as, for example electronic control unit 50. In other embodiments, deterrence component 210 can be implemented independently of the ECU. Deterrence component 210 in this example includes a communication component 201, and a potential threat detecting component 203 (including a processor 206 and memory 208 in this example). Components of deterrence component 210 are illustrated as communicating with each other via a data bus, although other communication in interfaces can be included.

The deterrence system 200 may include a plurality of sensors 152, one or more storage systems 250, and one or more other devices 290 which may be external to or internally located within the ego vehicle 2. In some embodiments, the one or more other devices 290 include one or more different computing or mobiles devices 291 and 292, and may be configured to receive a subset (e.g., a portion or all of) outputs from the deterrence component 210, either in real-time or in a delayed manner via V2N communication. Sensors 152, storage systems 250, and one or more other devices 290 can communicate with the deterrence component 210 via a wired or wireless communication interface. Although sensors 152, storage systems 250 and one or more other devices 290 are depicted as communicating with deterrence component 210, they can also communicate with each other as well as with other vehicle systems. In some embodiments, the one or more other devices 290 include one or more different computing or mobiles devices 291 and 292, and may be configured to receive a subset (e.g., a portion or all of) outputs from the deterrence component 210, either in real-time or in a delayed manner via V2N communication.

The potential threat detecting component 203 identifies a potential threat within a vicinity of the ego vehicle 2 and identifies or infers characteristics of the potential threat. A vicinity may refer to a particular radius of detection from the ego vehicle 2, and/or a detection range of sensors (e.g., the sensors 152). The potential threat detecting component 203 may include or be associated with one or more neural networks such as CNNs and/or transformers which may assist in inference of the characteristics of the potential threat. The potential threat detecting component 203 may identify one or more navigation characteristics such as a position, a velocity, a heading, or an acceleration of the potential threat, in absolute coordinates and/or relative coordinates with respect to the ego vehicle 2. The navigation characteristics may, additionally or alternatively, include historical navigation characteristics or time-series navigation characteristics such as a distance travelled within a previous interval of time, a trajectory, a frequency, a timing or rhythm, a pattern of movement, and/or a degree of erraticism of movement the of the potential threat. Examples of frequency may include a number or rate of repeated movements. The potential threat detecting component 203 may also identify one or more sensory characteristics such as visual, audio, and/or olfactory characteristics of the potential threat. For example, the audio and/or olfactory characteristics of the potential threat may include sounds and/or smells outputted from the potential threat. Visual characteristics may include, for a person, facial expressions, postures, body language, clothing (e.g. hoodie, mask), grooming such as hairstyle and makeup, overall appearance (e.g., degree of neatness), demeanor (e.g., degree of nervousness) and/or general characteristics such as age or gender.

In some embodiments, the potential threat detecting component 203 infers one or more attributes of the potential threat, which may include a type of the potential threat, a degree of severity of the potential threat, and/or a probability that the potential threat represents an actual threat. For example, the potential threat detecting component 203 may infer a higher degree of severity and/or a higher probability if the potential threat is moving towards the ego vehicle 2 faster and/or is brandishing a weapon. The deterrence component 210 determines and implements a deterrence action based on the sensor data captured or inferred by the potential threat detecting component 203 and/or based on the inferred attributes by the potential threat detecting component 203. In some embodiments, the deterrence action may include an output of an alarm and/or generating of an audio output. In some embodiments, the audio output may include a siren sound or a mimicked siren sound to create an impression that authorities are approaching nearby. The audio output may include an identification of the potential threat including one or more characteristics of the potential threat, a command, and/or a warning of an additional deterrence action in an event that the command is not complied with. An example audio output may be, “Person wearing a hoodie, step away from the vehicle and put down your weapon or else authorities will be dispatched.” In some embodiments, a tone, volume, speed, or other characteristics of the alarm and/or audio output may vary depending on any of the characteristics and/or attributes. For example, a potential threat of a high degree of severity and/or a high probability of representing an actual threat may result in a more urgent or serious tone, a higher volume, and/or a higher speed of the audio message. In some embodiments, the deterrence component 210 determines and implements a plurality of deterrence actions until the potential threat has been mitigated to below a threshold severity level. In some embodiments, the plurality of deterrence actions may be carried out sequentially or in a random order. In some embodiments, the plurality of deterrence actions may include progressively or iteratively increasing an urgency level of the deterrence actions if the potential threat remains unmitigated.

In some embodiments, the deterrence component 210 may recruit and deploy one or more neighboring vehicles to implement the deterrence actions. Deploying may include intelligently selecting one or more particular neighboring vehicles, transmitting a command to the one or more particular neighboring vehicles and/or otherwise controlling the one or more particular neighboring vehicles to implement the deterrence actions. The one or more neighboring vehicles may be stationary at the time of selection. In some embodiments, the implementation of the deterrence actions may be collaborated or coordinated among the ego vehicle 2 and the one or more neighboring vehicles.

The deterrence component 210 may intelligently select one or more neighboring vehicles to generate an audio output such as a mimicked siren sound. In some embodiments, the deterrence component 210 may configure one of more parameters of the audio output including a volume, a pitch, a timing, a directionality, and/or intervals between each audio output instance corresponding to a siren activation. In some embodiments, the deterrence component 210 may configure a volume of the siren sound to gradually increase over time in order to simulate a source of the siren sound getting closer. In some embodiments, the deterrence component 210 may configure a pitch to vary over time. For example, the pitch may be configured to initially be lower and gradually increase in order to provide an illusion of the source of the siren sound getting closer. In some embodiments, the deterrence component 210 may configure a timing of the siren sound. For example, the timing of the siren sound may have a slight delay between different vehicles to create an illusion that the sound is travelling from one location to another. In some embodiments, the deterrence component 210 may configure a directionality of the speakers within the vehicles to enhance perception of sound coming from multiple locations and to create an illusion of a moving sound source. In some embodiments, the deterrence component 210 may configure intervals between each siren activation on the vehicles. For example, the deterrence component 210 may start with longer intervals between the vehicles and gradually decrease the intervals to suggest that the sound is rapidly approaching.

After implementing the deterrence actions, a status of a degree of success of the deterrence actions may be transmitted to the storage systems 250, and/or to one or more AI or machine learning components to improve future determination of deterrence actions. The data structure within the storage systems 250 may be updated.

In some embodiments, as previously alluded to, determining the deterrence action is based on a data structure such as a table, as illustrated in FIG. 3B, an artificial intelligence (AI) component such as a generative AI component, or a machine learning component. As illustrated in FIG. 3B, deterrence action output data 310, including outputs of deterrence actions corresponding to different inputs (e.g., sensor data and/or inferred attributes) may be stored in storage systems 250. In some embodiments, the storage systems 250 may be part of the aforementioned remote server. The deterrence action output data 310 may be stored in a structured format, such as a tabular format (e.g., a lookup table). For example, the deterrence action output data 310 may include an output of one or more deterrence measures corresponding to a set of navigation characteristic inputs, sensory characteristic inputs, and/or inferred attributes.

Returning to FIG. 3A, sensors 152 can include, for example, sensors 52 such as those described above with reference to the example of FIG. 1. Sensors 152 can include additional sensors. In the illustrated example, sensors 152 may obtain navigation characteristics, sensory characteristics and/or other related data such as behavioral and/or interaction data of other objects external to the ego vehicle 2, and/or of occupants within the ego vehicle 2. The sensors 152 may include vehicle acceleration sensors 212, vehicle speed sensors 214, wheelspin sensors 216 (e.g., one for each steering wheel), head motion sensors 220 to detect rotational and/or translational motion of a head of a driver within the ego vehicle 2, eye tracking sensors 222 to detect eye movements of the driver, and environmental sensors 228 (e.g., to detect traffic density, speed of surrounding traffic, weather, air quality, and/or other environmental conditions). In some embodiments, sensor data from the environmental sensors 228 may affect whether or not an output from the deterrence component 210 is to be generated or displayed, and/or whether certain actions are to be implemented by the deterrence component 210. For example, if traffic density is high and/or the environment has hazy conditions, then certain actions may be less or more likely to be implemented. Additional sensors 232 can also be included as may be appropriate for a given implementation of deterrence system 200. The sensors 152 may be configured to detect and/or alert for any indications of anomalous behavior, as will be described below.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store any information used to perform a driver fitness test, for processor 206 as well as any other suitable information. Memory 208 can be made up of one or more modules of one or more different types of memory, and may be configured to store data and other information as well as operational instructions that may be used by the processor 206.

Although the example of FIG. 3A is illustrated using processor and memory components, as described below with reference to components disclosed herein, potential collision detecting component 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up collision detecting component 203 and/or deterrence component 210.

Communication component 201 includes either or both a wireless transceiver component 202 with an associated antenna 205 and a wired I/O interface 204 with an associated hardwired data port (not illustrated). As this example illustrates, communications with deterrence component 210 can include either or both wired and wireless communication components 201. Wireless transceiver component 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver component 202 and is used by wireless transceiver component 202 to transmit radio signals wirelessly to wireless equipment with which it is connected and to receive radio signals as well. These RF signals can include information of almost any sort that is sent or received by deterrence component 210 to/from other entities such as sensors 152 and storage systems 250.

Wired I/O interface 204 can include a transmitter and a receiver (not shown) for hardwired communications with other devices. For example, wired I/O interface 204 can provide a hardwired interface to other components, including sensors 152 and storage systems 250. Wired I/O interface 204 can communicate with other devices using Ethernet or any of a number of other wired communication protocols whether standardized, proprietary, open, point-to-point, networked or otherwise.

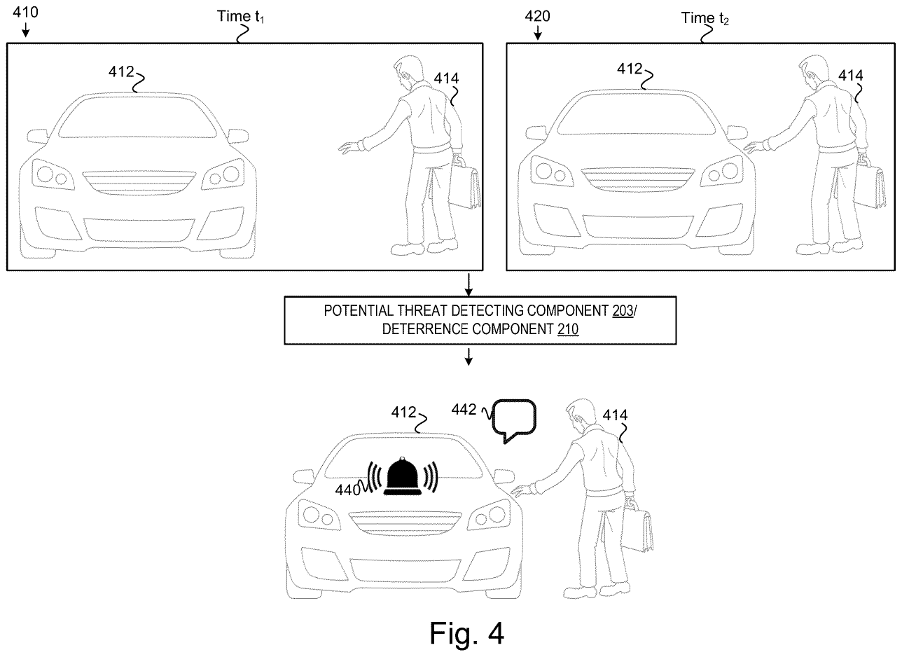

FIGS. 4-6 illustrate embodiments of the potential threat detecting component 203 and the deterrence component 210. In some embodiments, as illustrated in FIGS. 4-6, the potential threat detecting component 203 outputs an alarm or generates an output such as an audio and/or textual output. In some embodiments, the principles in FIGS. 4-6 may be applied in conjunction with FIG. 3A.

FIG. 4 illustrates an operation scenario 410 at a time t₁ and an operation scenario 420 at a time t₂ of an ego vehicle 412 and a potential threat 414, here, a person. As evident, between time t₁ and time t₂ the potential threat 414 has moved closer to the ego vehicle 412. In some embodiments, the ego vehicle 412 may be implemented as the ego vehicle 2. In some embodiments, the ego vehicle 412 may be stationary. Sensor data of the potential threat 414 and of the ego vehicle 412 between the operation scenarios 410 and 420 is obtained, captured, or inferred by the potential threat detecting component 203. The sensor data includes including navigation characteristics (e.g., relative position, relative velocity, and relative heading of the potential threat 414 relative to the ego vehicle 412) and sensory characteristics of the potential threat 414, such as the person carrying an object (e.g., a suitcase). The potential threat detecting component 203 infers one or more attributes such as a type of the potential threat 414, here, a person. The potential threat detecting component 203 may additionally or alternatively infer attributes such as a degree of severity of the potential threat 414 and/or a probability that the potential threat 414 represents an actual threat based on the sensor data.

The deterrence component 210 determines and implements one or more deterrence actions. Here, the deterrence actions may include outputting an alarm 440 and/or generating an audio output 442. Here, an example of a generated audio output 442 may identify that the potential threat 414 is a person, that the potential threat 414 is carrying a suitcase, and/or clothes that the potential threat 414 is wearing. An example of a generated audio output 442 may include, “Person wearing a long-sleeved shirt with black hair and carrying a suitcase, step away from the vehicle immediately or else authorities will be dispatched.” In other embodiments, the deterrence component 210 may implement other actions such as flashing lights, and/or textual outputs displayed visibly to the potential threat 414, analogous to the audio outputs.

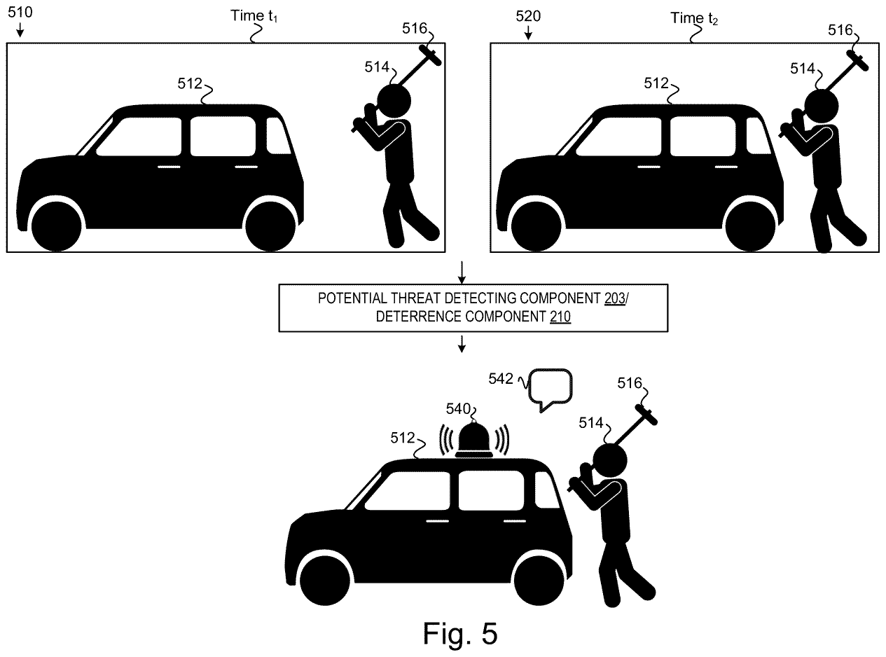

FIG. 5 illustrates an operation scenario 510 at a time t₁ and an operation scenario 520 at a time t₂ of an ego vehicle 512 and a potential threat 514, here, a person. As evident, between time t₁ and time t₂ the potential threat 514 has moved closer to the ego vehicle 512. In some embodiments, the ego vehicle 512 may be implemented as the ego vehicle 2. Sensor data of the potential threat 514 and of the ego vehicle 512 between the operation scenarios 510 and 520 is obtained, captured, or inferred by the potential threat detecting component 203. The sensor data includes including navigation characteristics (e.g., relative position, relative velocity, and relative heading of the potential threat 514 relative to the ego vehicle 512) and sensory characteristics of the potential threat 514, such as the person carrying an object (e.g., a weapon). The potential threat detecting component 203 infers one or more attributes such as a type of the potential threat 514, here, a person. The potential threat detecting component 203 may additionally or alternatively infer attributes such as a degree of severity of the potential threat 514 and/or a probability that the potential threat 514 represents an actual threat based on the sensor data.

The deterrence component 210 determines and implements one or more deterrence actions. Here, the deterrence actions may include outputting an alarm 540 and/or generating an audio output 542. Here, an example of a generated audio output 542 may identify that the potential threat 514 is a person, that the potential threat 514 is carrying a weapon, and/or clothes that the potential threat 414 is wearing. An example of a generated audio output 542 may include, “Person carrying a weapon, step away from the vehicle immediately and drop the weapon or else authorities will be dispatched.” In other embodiments, the deterrence component 210 may implement other actions such as flashing lights, and/or textual outputs displayed visibly to the potential threat 514, analogous to the audio outputs.

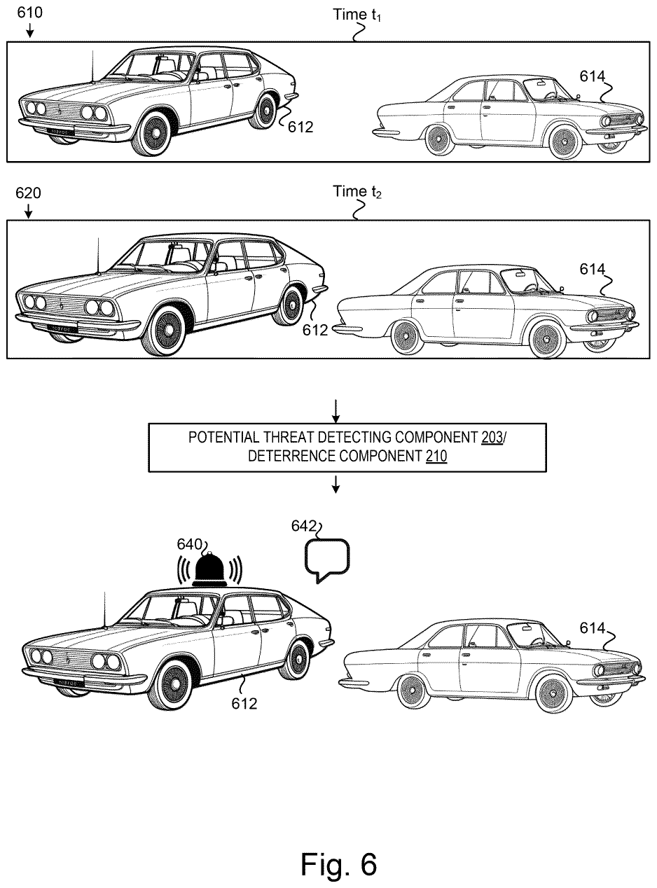

FIG. 6 illustrates an operation scenario 610 at a time t₁ and an operation scenario 620 at a time t₂ of an ego vehicle 612 and a potential threat 614, here, a different vehicle. As evident, between time t₁ and time t₂ the potential threat 614 has moved closer to the ego vehicle 612. In some embodiments, the ego vehicle 612 may be implemented as the ego vehicle 2. Sensor data of the potential threat 614 and of the ego vehicle 612 between the operation scenarios 610 and 620 is obtained, captured, or inferred by the potential threat detecting component 203. The sensor data includes including navigation characteristics (e.g., relative position, relative velocity, and relative heading of the potential threat 614 relative to the ego vehicle 612) and sensory characteristics of the potential threat 614, such as a color, a type of vehicle, a make or model, any occupants within the potential threat 614, and/or other identifying characteristics of the potential threat 614 such as license plate numbers. The potential threat detecting component 203 infers one or more attributes such as a type of the potential threat 614, here, a vehicle. The potential threat detecting component 203 may additionally or alternatively infer attributes such as a degree of severity of the potential threat 614 and/or a probability that the potential threat 614 represents an actual threat based on the sensor data.

The deterrence component 210 determines and implements one or more deterrence actions. Here, the deterrence actions may include outputting an alarm 640 and/or generating an audio output 642. Here, an example of a generated audio output 642 may identify that the potential threat 614 is a vehicle, that the potential threat 614 is backing towards the ego vehicle 612, and/or other characteristics of the potential threat 614. An example of a generated audio output 642 may include, “White sedan having a license plate number X, stop immediately.” In some embodiments, the generated audio output 642 may be directed to a communication system of the potential threat 614, for example, via V2N communications. Upon receiving the generated audio output 642, the potential threat 614 may autonomously stop to avoid a collision with the ego vehicle 612. Alternatively, an occupant such as a safety driver may manually stop the potential threat 614.

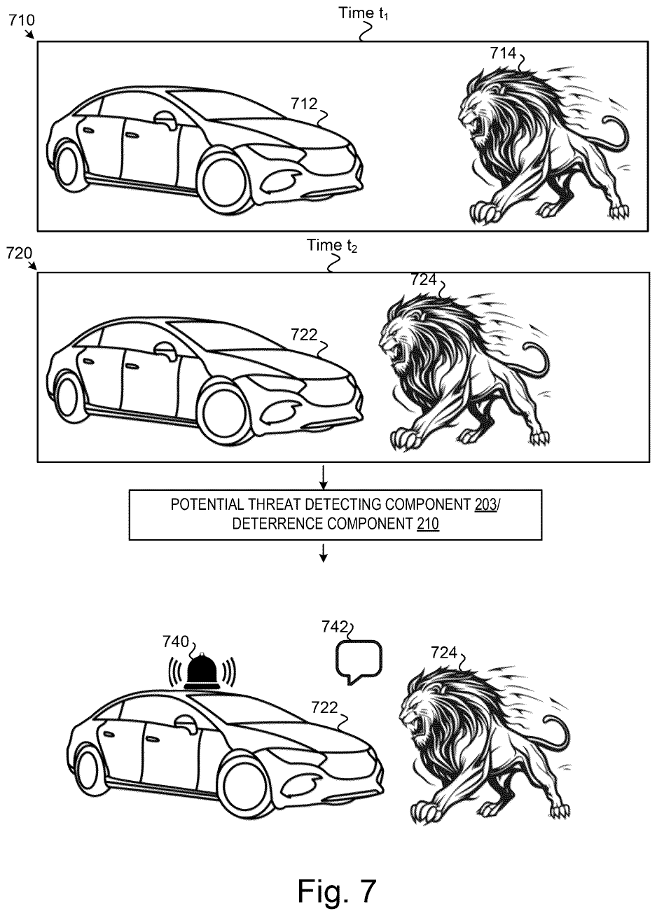

FIG. 7 illustrates an operation scenario 710 at a time t₁ and an operation scenario 720 at a time t₂ of an ego vehicle 712 and a potential threat 714, here, an animal (e.g., a bear, lion, or cat). As evident, between time t₁ and time t₂ the potential threat 714 has moved closer to the ego vehicle 712. In some embodiments, the ego vehicle 712 may be implemented as the ego vehicle 2. Sensor data of the potential threat 714 and of the ego vehicle 712 between the operation scenarios 710 and 720 is obtained, captured, or inferred by the potential threat detecting component 203. The sensor data includes including navigation characteristics (e.g., relative position, relative velocity, and relative heading of the potential threat 714 relative to the ego vehicle 612) and sensory characteristics of the potential threat 714, such as a color and/or other identifying characteristics of the potential threat 714. The potential threat detecting component 203 infers one or more attributes such as a type of the potential threat 714, here, a wild animal. The potential threat detecting component 203 may additionally or alternatively infer attributes such as a degree of severity of the potential threat 714 and/or a probability that the potential threat 714 represents an actual threat based on the sensor data.

The deterrence component 210 determines and implements one or more deterrence actions. Here, the deterrence actions may include outputting an alarm 740 and/or generating an audio output 742. Here, an example of a generated audio output 742 may include one or more warning sounds or noises that are particular adapted to scare off a particular type of animal. The generated audio output 742 may not include audible words because a wild animal would not understand the words. In some embodiments, the generated audio output 742 may include a warning message to inform other humans regarding the presence of a wild animal.

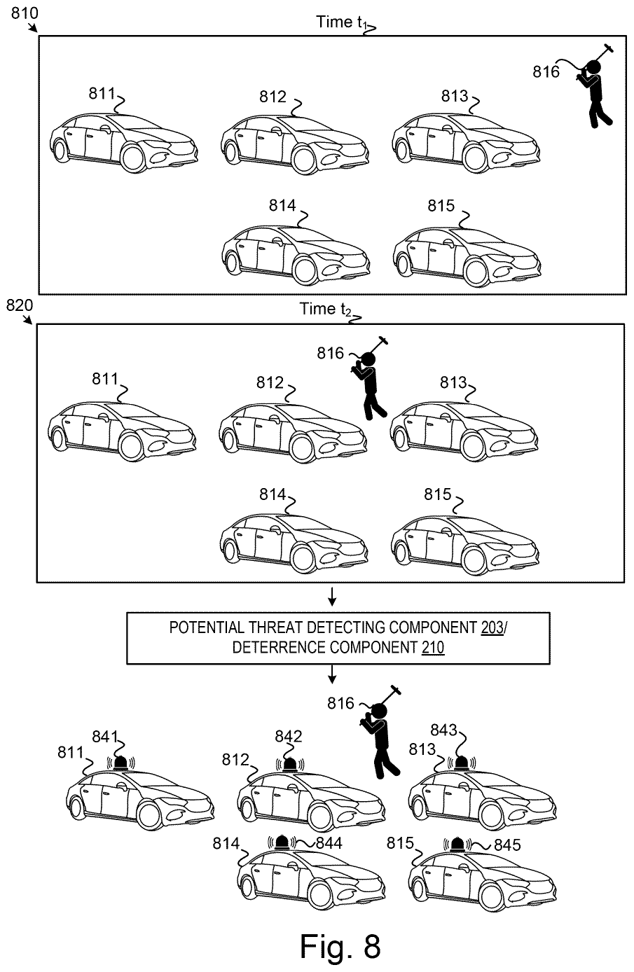

FIG. 8 illustrates an operation scenario 810 at a time t₁ and an operation scenario 820 at a time t₂ of an ego vehicle 811, neighboring vehicles 812-815, and a potential threat 816, here, a person. As evident, between time t₁ and time t₂ the potential threat 816 has moved closer towards the neighboring vehicle 812. In some embodiments, the ego vehicle 811 may be implemented as the ego vehicle 2. Sensor data of the potential threat 814 and of or near the ego vehicle 811, and the neighboring vehicles 812-815 is obtained, captured, or inferred by the potential threat detecting component 203. The sensor data may be taken at time periods between and/or including the operation scenarios 810 and 820. The sensor data includes including navigation characteristics (e.g., relative position, relative velocity, and relative heading of the potential threat 816 relative to the ego vehicle 811) and sensory characteristics of the potential threat 816, such as a color and/or other identifying characteristics of the potential threat 816. The potential threat detecting component 203 infers one or more attributes such as a type of the potential threat 816, here, a wild animal. The potential threat detecting component 203 may additionally or alternatively infer attributes such as a degree of severity of the potential threat 816 and/or a probability that the potential threat 816 represents an actual threat based on the sensor data.

The deterrence component 210 determines and implements one or more deterrence actions. Here, the deterrence actions may include outputting an alarm 841 or other audio output (hereinafter “alarm”). The alarm may mimic a voice of a siren or other warning. The deterrence actions may, additionally or alternatively, include deploying any of the one or more neighboring vehicles 812, 813, 814, and 815 to output respective alarms 842, 843, 844, and 845. For example, based on a current location of the potential threat 816 and/or a future predicted location of the potential threat 816, the deterrence actions may include deploying the one or more neighboring vehicles 812, 813, 814 and/or 815 to output a coordinated alarm to simulate an authority vehicle such as a police car getting closer toward the current location or the predicted future location. As a specific, nonlimiting example, the deterrence component 210 may deploy one or more of the neighboring vehicles 812, 813, 814 and/or 815 to gradually increase a volume of the alarm 842 over a time period. The deployment may include deploying one of the neighboring vehicles (e.g., the neighboring vehicle 812) to increase a volume of a corresponding alarm (e.g., the alarm 842) over the time period. As another specific example, the deployment may include varying volumes of the alarms 842, 843, 844, and 845 such that the alarms 842, 843, 844, and 845 have different volumes, in order to simulate approaching authority vehicles from different directions. Thus, varying of the volumes of the alarms 841, 842, 843, 844, and 845 may be performed across both space and time.

Similarly, a pitch of any of the alarms 841, 842, 843, 844, and/or 845 may be varied over time. As another example, a timing of any of the alarms 841, 842, 843, 844, and/or 845 may be staggered such that the alarms 841, 842, 843, 844, and/or 845 are triggered at different times. As another example, a directionality of any of the alarms 841, 842, 843, 844, and/or 845 (e.g., a direction to which the alarms are directed towards) may also be varied across the alarms 841, 842, 843, 844, and/or 845, and/or varied over a time period. As another example, an interval between each individual alarm triggering and/or between successive different alarms, a wavelength, and/or a period of the alarms may be varied. An initial interval between each individual alarm and/or between successive different alarms may be longer, and over time, the interval may be shorted to provide an impression that a source of the alarms is rapidly approaching.

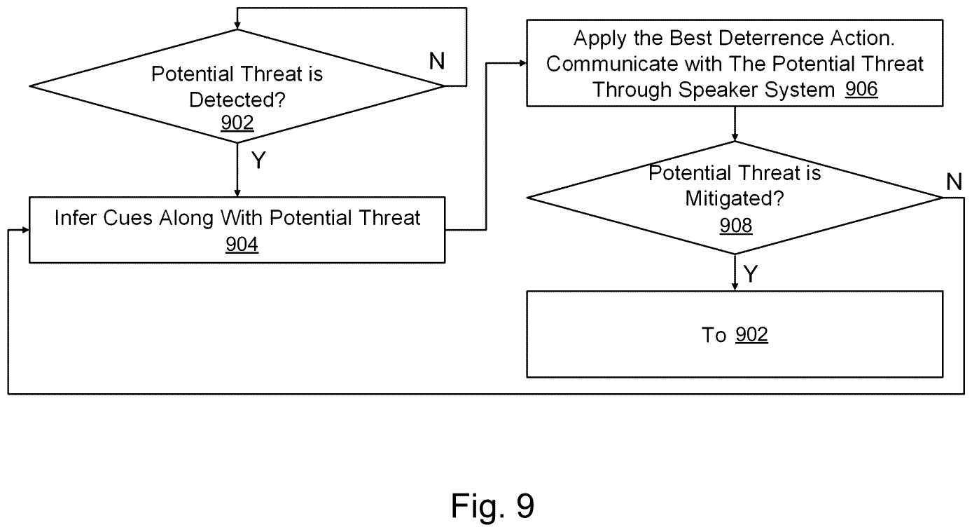

FIG. 9 is a flowchart of a method of deterrence of a potential threat, consistent with FIGS. 1-2, 3A, 3B, and 4-7. In decision 902, the potential threat detecting component 203 determines whether a potential threat has been detected from sensor data. If not, then the potential threat detecting component 203 continues to obtain or detect sensor data until a potential threat is detected. In step 904, responsive to a positive determination in decision 902, the potential threat detecting component 203 infers one or more cues associated with the detected potential threat. The one or more cues may include navigation characteristics and/or sensory characteristics. In step 906, the deterrence component 210 applies one or more deterrence actions. In some examples, the one or more deterrence actions may communicate with the potential threat via a vehicle speaker system. For example, the one or more deterrence actions may include an alarm at fixed or varying volume, frequency, and/or other alarm characteristics. The one or more deterrence actions may include an audio output or other output. In decision 908, the deterrence component 210 or the potential threat detecting component 203 determines whether the potential threat has been sufficiently mitigated (e.g., a degree of severity of the potential threat has fallen to below a threshold severity). In response to a negative determination, the deterrence component 210 returns to step 904. In response to a positive determination, the deterrence component returns to decision 902.

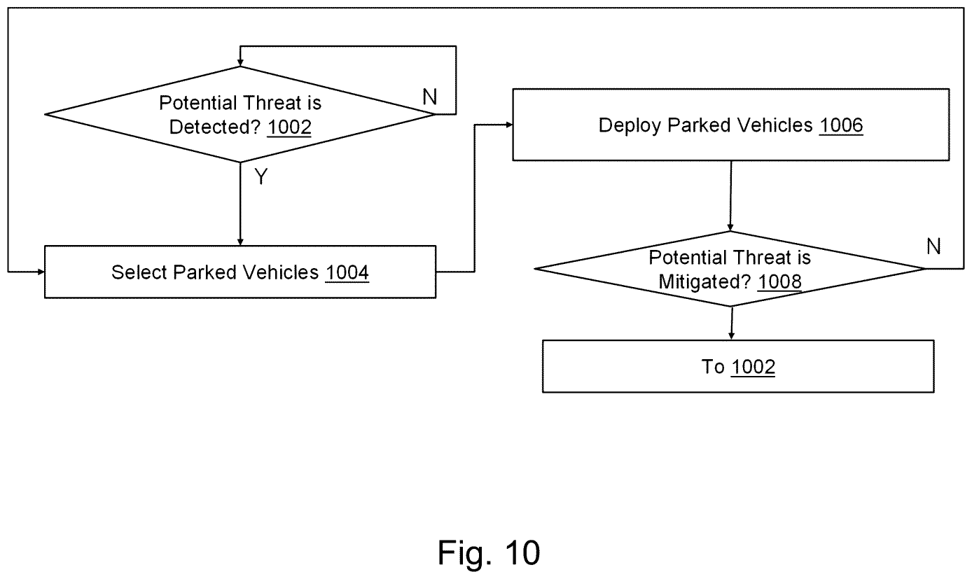

FIG. 10 is a flowchart of a method of deterrence of a potential threat, consistent with FIG. 8. In decision 1002, the potential threat detecting component 203 determines whether a potential threat has been detected from sensor data. If not, then the potential threat detecting component 203 continues to obtain or detect sensor data until a potential threat is detected. In step 1004, responsive to a positive determination in decision 1002, the potential threat detecting component 203 selects one or more neighboring vehicles to be deployed. In step 1006, the deterrence component 210 deploys any of the selected neighboring vehicles to apply one or more deterrence actions. In some examples, the one or more deterrence actions may include causing any of the selected neighboring vehicles to output an alarm that resembles a siren sound in a coordinated manner. In decision 1008, the deterrence component 210 or the potential threat detecting component 203 determines whether the potential threat has been sufficiently mitigated (e.g., a degree of severity of the potential threat has fallen to below a threshold severity). In response to a negative determination, the deterrence component 210 returns to step 1004. In response to a positive determination, the deterrence component returns to decision 1002.

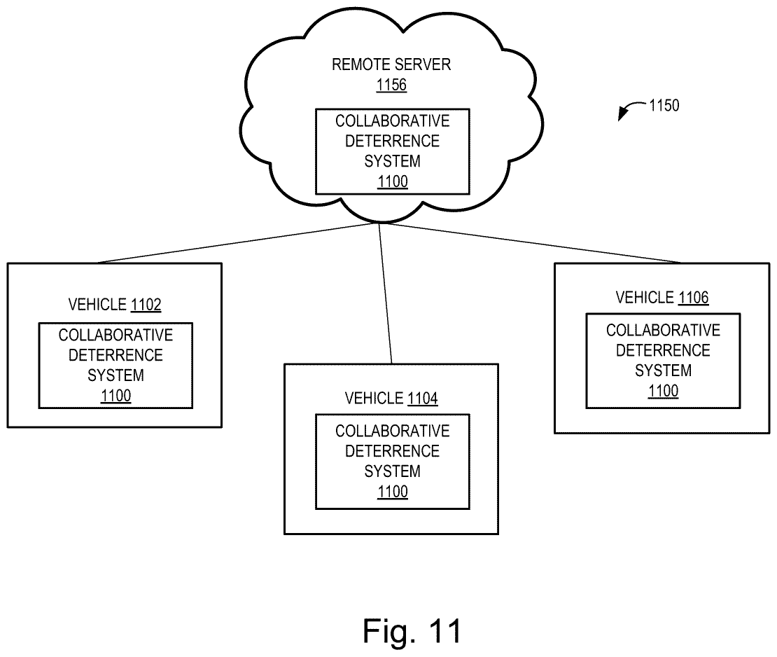

FIG. 11 illustrates an example implementation of a collaborative deterrence system 1100, in accordance with various embodiments of the presently disclosed technology. Collaborative deterrence system 1100 may be a particular implementation of deterrence system 200 from FIG. 3A.

As alluded to above, a shortcoming of many existing deterrence systems is that they operate individually without coordination. As perpetrators assess their surroundings and choose a target, in many cases vehicles will independently detect suspicious activity and respond with their own independent deterrence actions. Suspicious activity may take many different forms. Suspicious activity around a vehicle typically involves actions that appear out of place, evasive, or potentially unlawful. Individuals may loiter near a vehicle without a clear purpose, often glancing around or checking their surroundings nervously. They might try door handles, peer into windows—sometimes using a flashlight—or circle the vehicle repeatedly. Attempts to manipulate locks, use tools near windows, or remove items in a hurried or discreet manner, especially if accompanied by efforts to hide their face or avoid surveillance cameras, indicate suspicious behavior. Wearing inappropriate clothing for the weather, such as a hood on a warm day, can also be a sign of suspicious activity. In many cases, these individuals may quickly walk away or pretend to be engaged in another activity when approached. While context is important (e.g., such as delivery personnel or people waiting for rides) the combination and pattern of these behaviors can indicate potential criminal intent. Thus, suspicious activity may be detected by observing such behaviors alone or in combination in the context of the then-current situation.

As collaborative deterrence system 1100 is designed in appreciation of, collaborative deterrence can be far more effective at deterring suspicious activity than existing deterrence systems which operate independently without coordination. By sharing inferred knowledge among nearby vehicles, collaborative deterrence system 1100 can track a suspicious individual's movements across multiple vehicles and alert innocent drivers before they park in vulnerable spots. Collaborative deterrence system 1100 enables multiple vehicles (e.g., vehicles 1102, 1104 and 1106) to act in coordination, enhancing deterrence and overall vehicle safety. Additionally, if perpetrators break into a vehicle, collaborative deterrence system 1100 can continue tracking their movements, providing valuable evidence for authorities.

For example (and as described in greater detail below), vehicles inspected by suspicious individuals can use AI to generate natural language descriptions of suspicious individuals and their activities. These natural language descriptions can be shared among the vehicles, along with recorded videos and audio (e.g., conversations between suspicious individuals). Facilitated/orchestrated by collaborative deterrence system 1100, the vehicles can then coordinate collaborative deterrence actions. For example, vehicle 1102 may display recorded video of a suspicious individual on its dashboard, while vehicles 1104 and 1106 play audio of another suspicious individual. Such a collaborative deterrence strategy can reinforce that the suspicious individuals are being tracked and recorded from the start. Accordingly, collaborative deterrence system 1100/vehicles 1102-1106 can effectively come up with a collaborative deterrence strategy to protect vehicles 1102-1106 and their surroundings. This collaborative approach not only helps to prevent suspicious activities, but also enhances the overall security of vehicles and their environment.

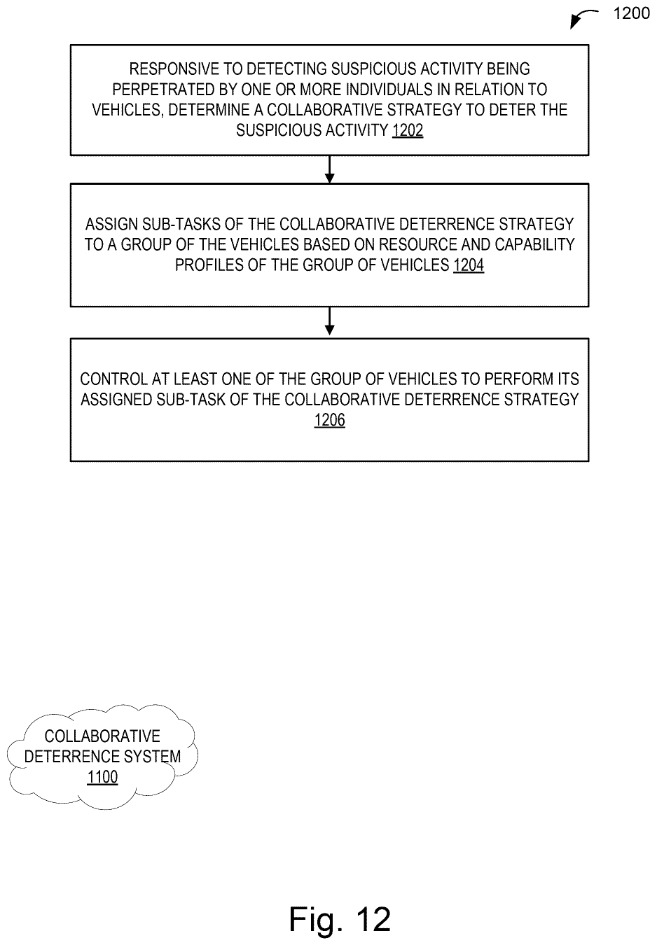

As described in greater detail in conjunction with FIG. 12, collaborative deterrence system 1100 may improve upon potential alternative designs by intelligently assigning sub-tasks of a collaborative deterrence strategy to different vehicles based on resource and capability profiles of the different vehicles. For example, collaborative deterrence system 1100 can intelligently assign sub-tasks of a collaborative deterrence strategy to vehicles 1102, 1104 and 1106 based on at least one of: (a) differences in sensor resources across vehicles 1102-1106; (b) differences in processing resources across vehicles 1102-1106; (c) differences in wireless communication resources across vehicles 1102-1106; (d) differences in audio-visual output capabilities across vehicles 1102-1106; or (e) differences in autonomous driving capabilities across vehicles 1102-1106.

As a more specific example, collaborative deterrence system 1100 may determine that vehicle 1102 has superior processing resources to vehicles 1104 and 1106. Accordingly, collaborative deterrence system 1100 may: (i) assign vehicle 1102 to further analyze activity of one or more suspicious individuals in relation to vehicles 1102-1106; and (ii) assign vehicles 1104 and 1106 to perform less processor-intensive sub-tasks of the collaborative deterrence strategy (e.g., video and audio recording, sounding an alarm, displaying video of the suspicious individuals, moving autonomously to disorient or spook the suspicious individuals, etc.). As another example, collaborative deterrence system 1100 may determine that vehicle 1102 has superior audio output capabilities (e.g., a louder speaker, a speaker with great sound/pitch modulation capabilities, a speaker that is able to play back audio of suspicious individuals, etc.) to vehicles 1104 and 1106. Accordingly, collaborative deterrence system 1100 can: (i) assign vehicle 1102 to output an audio-based deterrence action (e.g., an audio alarm or warning, playing back recorded audio of the suspicious individuals, etc.); and (ii) assign vehicles 1104 and 1106 to perform non-audio output-related sub-tasks of the collaborative deterrence strategy (e.g., video and audio recording of the suspicious individuals, analyzing video and audio recording of the suspicious individuals, displaying video of the suspicious individuals, moving autonomously to disorient or spook the suspicious individuals, etc.). In sum, by intelligently assigning sub-tasks of a collaborative deterrence strategy to different vehicles based on resource and capability profiles of the different vehicles, collaborative deterrence system 1100 can improve upon potential alternative designs which do not consider this intelligent and tailored assignment of sub-tasks.

Referring again to the architecture of FIG. 11, in some embodiments collaborative deterrence system 1100 may be implemented across a remote server 1156 and one or more vehicles, such as vehicle 1102, vehicle 1104, and vehicle 1106 (each of which may be an example of ego vehicle 2 from FIG. 1 or vehicle 100 from FIG. 2). In various implementations, vehicles 1102-1106 may be parked in a common location (e.g., a parking lot). However, in other implementations one or more of vehicles 1102-1106 may be moving.

As depicted, collaborative deterrence system 1100 may be facilitated by a remote environment 1150. In some embodiments, remove environment 1150 may comprise a cloud-based environment. In other embodiments, remote environment 1150 may comprise an edge-based environment. Such an edge-based environment can utilize various types of edge infrastructure, such as roadside/traffic infrastructure, infrastructure (e.g., a dedicated server) proximate a parking lot where vehicles 1102-1106 are parked, cellular network infrastructure, etc. In some implementations, remote environment 1150 may be a combination of a cloud-based environment and an edge-based environment.

Accordingly, collaborative deterrence system 1100 may include separate instances within one or more entities of remote environment 1150, such as remote server 1156, vehicle 1102, vehicle 1104, and vehicle 1106. In a further aspect, the entities that implement collaborative deterrence system 1100 within remote environment 1150 may vary beyond transportation-related devices and encompass roadside infrastructure elements. Thus, the set of entities that function in coordination with remote environment 1150 may be varied.

In some embodiments, vehicles 1102-1106 may form collaborative deterrence system 1100 by forming a peer-to-peer/ad-hoc network, such as a vehicular micro-cloud (VMC). In such embodiments, remote server 1150 can oversee/orchestrate the collaboration among vehicles.

In some embodiments, remote environment 1150 itself may comprise a dynamic environment that comprises VMC members that migrate into and out of a geographic area.

FIG. 12 illustrates an example method 1200 that may be performed by collaborative deterrence system 1100 to deter suspicious activity in relation to vehicles, in accordance with various embodiments of the presently disclosed technology.

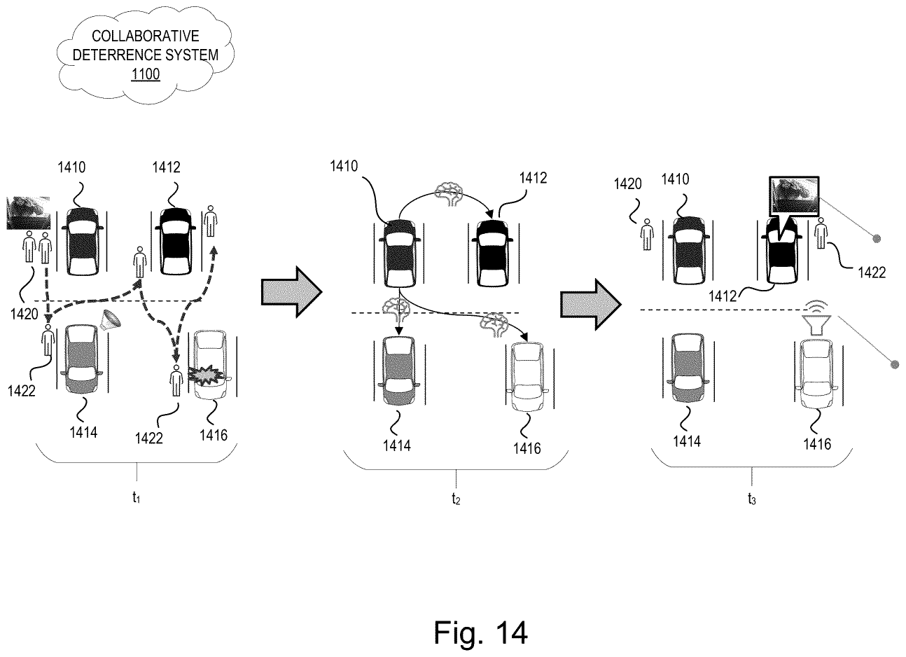

Responsive to detecting suspicious activity being perpetrated by one or more individuals in relation to vehicles, collaborative deterrence system 1100 can perform operation 1202 to determine a collaborative strategy to deter the suspicious activity. Examples of such a collaborative deterrence strategy are described in greater detail in conjunction with FIGS. 14-18.

According to some aspects, detecting the suspicious activity may be based on detecting suspicious behaviors, alone or in combination, by the one or more individuals in the context of the then-current situation. Threshold levels can be set, and the behavior can be observed according to the threshold levels. If the suspicious activity rises above a determined threshold, collaborative deterrence system 1100 may determine that the one or more individuals are acting suspiciously in relation to the vehicles.

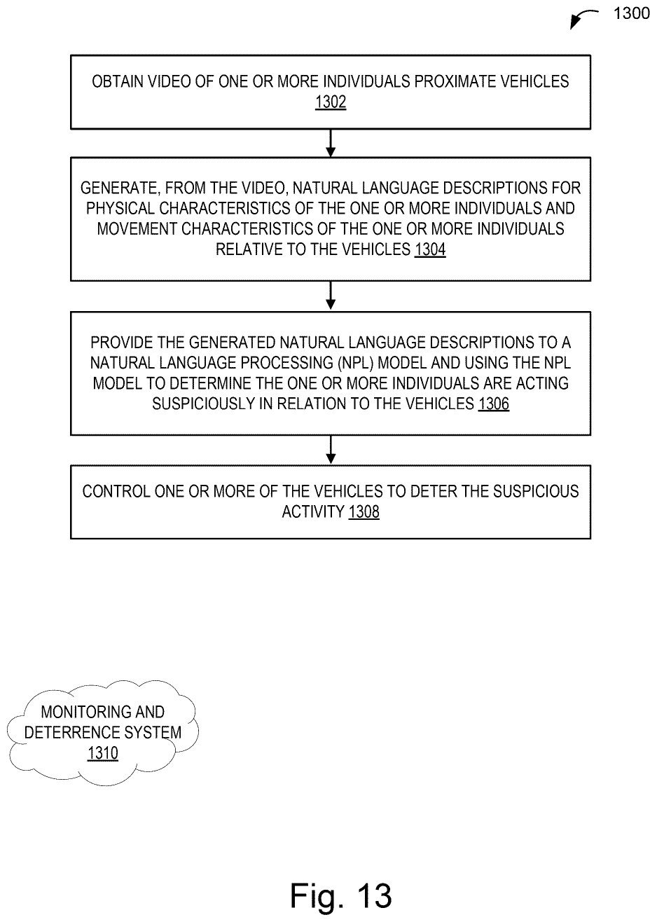

As described in greater detail in conjunction with FIG. 13, in some implementations collaborative deterrence system 1100 can detect the suspicious activity by: (1) obtaining video of the one or more individuals (e.g., from video-recording cameras of one or more of the vehicles); (2) generating, from the video, natural language descriptions for physical characteristics of the one or more individuals and movement characteristics of the one or more individuals relative to the vehicles; and (3) providing the generated natural language descriptions to a natural language processing (NPL) model and using the NPL model to determine the one or more individuals are acting suspiciously in relation to the vehicles.

After determining the collaborative deterrence strategy, collaborative deterrence system 1100 can perform operation 1204 to assign sub-tasks of the collaborative deterrence strategy to a group of the vehicles based on resource and capability profiles of the group of vehicles. For example, assigning the sub-tasks of the collaborative deterrence strategy to the group of the vehicles may be based on at least one of: (a) differences in sensor resources across the group of vehicles; (b) differences in processing resources across the group of vehicles; (c) differences in wireless communication resources across the group of vehicles; (d) differences in audio-visual output capabilities across the group of vehicles; or (e) differences in autonomous driving capabilities across the group of vehicles.

As an example, the group of vehicles may comprise at least a first vehicle and a second vehicle and assigning the sub-tasks of the collaborative deterrence strategy to the first and second vehicles may comprise: (i) determining the first vehicle has superior processing resources to the second vehicle; (ii) assigning the first vehicle to further analyze the activity of the one or more individuals in relation to the vehicles; and (iii) assigning the second vehicle to perform a less processor-intensive sub-task of the collaborative deterrence strategy (e.g., recording further audio or video of the one or more individuals, sounding a warning or alarm, playing back recorded audio of the one or more individuals, displaying recorded video of the one or more individuals, etc.).

As a second example, collaborative deterrence system 1100 may: (i) determine the first vehicle has superior audio output capabilities (e.g., a louder speaker or alarm, a speaker with greater sound/pitch modulation capabilities, a speaker capable of playing back audio of the one or more individuals, etc.) to the second vehicle; (ii) assign the first vehicle to output an audio-based deterrence action (e.g., sounding an audio alarm or warning, playing recorded audio of the suspicious individuals, etc.); and (iii) assign the second vehicle to perform a non-audio output-related sub-task of the collaborative deterrence strategy (e.g., recording further audio or video of the one or more individuals, analyzing the foregoing recorded audio or video, displaying recorded video of the one or more individuals, moving autonomously to spook or disorient the one or more individuals, etc.).

As a third example, collaborative deterrence system 1100 may: (i) determine the first vehicle has a superior visual display (e.g., a larger visual display, a higher resolution visual display, etc.) to the second vehicle; (ii) assign the first vehicle to display video of the one or more individuals on its superior visual display; and (iii) assign the second vehicle to perform a non-visual output-related sub-task of the collaborative deterrence strategy (e.g., recording further audio or video of the one or more individuals, analyzing the foregoing recorded audio or video, sounding an audio alarm or warning, playing recorded audio of the suspicious individuals, moving autonomously to spook or disorient the one or more individuals, etc.).

As a fourth example, collaborative deterrence system 1100 may: (i) determine the first vehicle has superior autonomous driving capabilities (e.g., superior fully or semi-autonomous driving features, superior parking assist features, a superior advanced driver-assistance system (ADAS), etc.) to the second vehicle; (ii) assign the first vehicle to move autonomously to deter the suspicious activity; and (iii) assign the second vehicle to perform a non-autonomous driving-related sub-task of the collaborative deterrence strategy (e.g., recording further audio or video of the one or more individuals, analyzing the foregoing recorded audio or video, sounding an audio alarm or warning, playing recorded audio of the suspicious individuals, playing recorded video of the suspicious individuals, etc.).

In some implementations, collaborative deterrence system 1100 may also consider detected positional relationships between the one or more individuals and respective vehicles of the group of vehicles when intelligently assigning the sub-tasks of the collaborative deterrence strategy to the group of the vehicles. For example, collaborative deterrence system 1100 may assign the sub-tasks based on detected location and attentional direction of the one or more individuals with respect to respective vehicles of the group of vehicles. As a more specific example (and where the group of vehicles comprises at least a first vehicle and a second vehicle), collaborative deterrence system 1100 may: (i) determine that at least one of the one or more individuals is gazing into the first vehicle; (ii) assign the first vehicle to display video of the one or more individuals on a visual display within the first vehicle; and (iii) assigning the second vehicle to perform a non-visual output-related sub-task of the collaborative deterrence strategy.

After assigning the sub-tasks of the collaborative deterrence strategy to the group of vehicles, collaborative deterrence system 1100 can perform operation 1206 to control at least one of the group of vehicles to perform its assigned sub-task.

While not directly depicted in FIG. 12, in some implementations collaborative deterrence system 1100 can determine a collaborative strategy to further monitor the suspicious activity as well. Accordingly, collaborative deterrence system 1100 can assign sub-tasks of the collaborative monitoring strategy to the group of vehicles based on: (a) the resource and capability profiles of the group of vehicles; and (b) positional relationships between the one or more individuals and respective vehicles of the group of vehicles (or more specifically, positional relationships between the one or more individuals and respective sensors of the group of vehicles). This may involve assigning the sub-tasks of the collaborative monitoring strategy to the group of the vehicles based on at least one of: (i) differences in audio-recording resources and capabilities across the group of vehicles; (ii) differences in video-recording resources and capabilities across the group of vehicles; or (iii) differences in motion tracking resources and capabilities across the group of vehicles.

FIG. 13 illustrates an example natural language processing-based method 1300 that may be performed by a monitoring and deterrence system 1310 to determine individuals are acting suspiciously in relation to vehicles, in accordance with various embodiments of the presently disclosed technology. Monitoring and deterrence system 1310 may be a particular implementation of deterrence system 200 from FIG. 3A, a particular implementation of collaborative deterrence system 1100 from FIG. 11, or a combination thereof.

Monitoring and deterrence system 1310 may improve upon potential alternative designs by inferring useful cues from video and audio recordings of individuals proximate vehicles, and determining the individuals are acting suspiciously based on the cues. Examples of cues may include visual cues, motion cues, audio cues, or a combination thereof.

An example visual cue may comprise an observation that a first individual is female and wearing a mask, while a second individual is male and dressed in blue jeans and a red t-shirt.

An example motion cue may comprise an observation that the first individual is looking inside vehicles while the second individual is scanning the surrounding area. As another example, a motion cue may comprise an observation that both individuals are craning their necks left and right to check the street proximate the vehicles and pausing when they notice other people nearby.

An example audio cue may comprise an observation that the first individual instructed the second individual to “check the surroundings and let me know if anyone shows up,” and “whistle when necessary.”

From these cues, monitoring and deterrence system 1310 can determine that the first and second individuals are acting suspiciously in relation to the vehicles. For example, monitoring and deterrence system 1310 may reason that the two individuals are systematically checking vehicles one by one and inspecting their interiors. Monitoring and deterrence system 1310 may further infer that the individuals are coordinating their actions using a whistle as a signal whenever someone else appears in the vicinity.

Monitoring and deterrence system 1310 can utilize one or more AI models to perform this cue-based reasoning. Relatedly, monitoring and deterrence system 1310 can utilize AI model(s) to generate the above-described cues.

For example, monitoring and deterrence system 1310 can utilize one or more AI models to generate natural language descriptions of physical characteristics (e.g., height, weight, gender, clothing, and other distinguishing physical characteristics) of the first and second individuals from the video of the two individuals. Similarly, monitoring and deterrence system 1310 can the utilize AI model(s) to generate natural language descriptions for movement patterns of the first and second individuals from the video of the two individuals. Such natural language descriptions may form a basis for the above-described visual and motion cues.

In certain implementations, the above-described AI model(s) may comprise Vision Language Model(s). As used herein, a Vision Language Model (VLM) may refer to an AI model that combines/blends computer vision and natural language processing (NLP) functionalities. For example, the VLM may combine one or more vision machine learning models with one or more NPL models (e.g., a large language model (LLM)). Accordingly, the VLM can effectively integrate visual and textual data.

An example VLM may comprise a vision encoder and a language encoder.

The vision encoder may convert image data into embeddings (e.g., numerical or vector representations) that capture key characteristics of the image data (e.g., colors, objects, shapes, textures, etc.). Examples of the vision encoder may include convolutional neural networks (CNNs) and Vision Transformers.

The language encoder may process text (i.e., natural language descriptions) to capture/understand semantic meaning and contextual relationships between words and phrases. This may involve tokenizing the text, and converting each token into an embedding (e.g., a numerical or vector representation) which represents/captures semantic meaning and contextual associations of the text associated with a given token.

To understand the embeddings derived from these two modalities, the VLM may perform a cross-modal alignment that matches embeddings of visual and textual features in a shared embedding space. After this cross-modal alignment, the VLM may fuse the embeddings/features in a shared representation space. Such fusion can help the VLM make decisions based on both modalities simultaneously.

As alluded to above, monitoring and deterrence system 1310 may utilize one or more VLMs to generate detailed natural language descriptions of the first and second individuals and their movement patterns. Such visual and motion cues, in the form of generated natural language descriptions, may then be shared among vehicles.

In some implementations, monitoring and deterrence system 1310 can also generate natural language descriptions for speech (e.g., a conversation between the first and second individuals) and non-speech-related activity (e.g., audio of one of the individuals attempting to saw off a catalytic converter from one of vehicles) of the first and second individuals based on the recorded audio of the individuals. In some implementations, this may comprise utilizing an NPL model or other AI model designed/trained to analyze audio data.

The above-described audio cues, in the form of natural language descriptions, may be integrated with the above-described visual and motion cues, and shared among vehicles.

As described above, monitoring and deterrence system 1310 can utilize the above-described cues to determine the first and second individuals are acting suspiciously in relation to vehicles. For example (and as described above), monitoring and deterrence system 1310 may reason that the two individuals are systematically checking vehicles one by one and inspecting their interiors. Monitoring and deterrence system 1310 may further infer that the two individuals are coordinating their actions using a whistle as a signal whenever someone else appears in the vicinity.

Referring now to method 1300, monitoring and deterrence system 1310 can perform operation 1302 to obtain video of one or more individuals proximate vehicles. As alluded to above, the video may be obtained from one or more video-recording cameras of the vehicles.

Monitoring and deterrence system 1310 can then perform operation 1304 to generate, from the video, natural language descriptions for physical characteristics of the one or more individuals and movement characteristics of the one or more individuals relative to the vehicles. As described above, this may involve using one or more one or more VLMs. In various implementations, the one or more VLMs may be trained on both daytime data and nighttime data where VLM-generated results can be compared to ground truth data for improvement and validation of the models.

Monitoring and deterrence system 1310 can perform operation 1306 to provide the generated natural language descriptions to a NPL model and use the NPL model to determine the one or more individuals are acting suspiciously in relation to the vehicles. In some implementations, the one or more VLMs used to generate the natural language descriptions of operation 1304 may comprise the NPL model. In various implementations, the NPL model/one or more VLMs can understand the visual, motion, and audio cues to determine that suspicious activity is actually being perpetrated by the one or more individuals.

Accordingly, monitoring and deterrence system 1310 can then perform operation 1308 to control one or more of the vehicles to deter the suspicious activity. As described above in conjunction with FIGS. 11-12, in some implementations controlling the one or more of the vehicles to deter the suspicious activity may comprise: (a) determining a collaborative strategy to deter the suspicious activity; (b) assigning sub-tasks of the collaborative deterrence strategy to a group of the vehicles based on resource and capability profiles of the group of vehicles; and (c) controlling at least one of the group of vehicles to perform its assigned sub-task of the collaborative deterrence strategy.

While not depicted in the specific example of FIG. 13, in some implementations monitoring and deterrence system 1310 can perform operations to: (1) obtain (e.g., from one or more audio sensors of the vehicles), audio associated with speech and non-speech-related activity of the one or more individuals; and (2) generate, from the audio, natural language descriptions for the speech and the non-speech-related activity of the one or more individuals. Here, the natural language descriptions for the speech and the non-speech-related activity of the one or more individuals may also be provided to the NPL and used by the NPL to determine the one or more individuals are acting suspiciously in relation to the vehicles.

FIG. 14 depicts a first example collaborative deterrence strategy, in accordance with various embodiments of the presently disclosed technology.

As depicted, collaborative deterrence system 1100 may perform/facilitate the first example collaborative deterrence strategy. In some implementations, collaborative deterrence system 1110 may be implemented across one or more of vehicles 1410, 1412, 1414, and 1416. In certain of such implementations, vehicles 1410-1416 may form a peer-to-peer/ad-hoc wireless communication network, such as a vehicular micro-cloud (VMC).

As depicted, during a time period t₁, vehicles 1410 and 1414 may record activities of individuals 1420 and 1422 in relation to vehicles 1410-1416. For example, vehicles 1410 and 1414 can utilize their video-recording cameras and audio-recording sensors respectively to record the activity of individuals 1420 and 1422.

Collaborative deterrence system 1100 can then analyze the recorded video and audio of individuals 1420 and 1422 to determine individuals 1420 and 1422 are acting suspiciously in relation to vehicles 1410-1416 (e.g., planning to, or in the process of, vandalizing or stealing from one or more of vehicles 1410-1416).

The above-described analysis may involve inferring useful cues from the video and audio recordings, and determining individuals 1420 and 1422 are acting suspiciously based on the cues. As described above, examples of cues may include visual cues, motion cues, audio cues, or a combination thereof.

In the context of FIG. 14, the visual cues may comprise an observation that individual 1422 is female and wearing a mask, while individual 1420 is male and dressed in blue jeans and a red t-shirt.

In the context of FIG. 14, the motion cues may comprise an observation that individual 1422 is looking inside vehicles 1410-1416 while individual 1420 is scanning the surrounding area. As another example, a motion cue may comprise an observation that both individuals are craning their necks left and right to check the street proximate vehicles 1410-1416 and pausing when they notice other people nearby.

In the context of FIG. 14, the audio cues may comprise an observation that individual 1422 instructed individual 1420 to “check the surroundings and let me know if anyone shows up” and “whistle when necessary.”

From these cues, collaborative deterrence system 1100 can determine that individuals 1420 and 1422 are acting suspiciously in relation to vehicles 1410-1416. For example, collaborative deterrence system 1100 may reason that the two individuals are systematically checking vehicles one by one and inspecting their interiors. Collaborative deterrence system 1100 may further infer that the individuals are coordinating their actions using a whistle as a signal whenever someone else appears in the vicinity.

As described above, collaborative deterrence system 1100 can utilize one or more AI models to perform this cue-based reasoning. Relatedly, collaborative deterrence system 1100 can utilize AI model(s) to generate the cues themselves.

For example, collaborative deterrence system 1100 can utilize one or more AI models to generate natural language descriptions of physical characteristics (e.g., height, weight, gender, clothing, and other distinguishing physical characteristics) of individuals 1420 and 1422 from the video of individuals 1420 and 1422. Similarly, collaborative deterrence system 1100 can the utilize AI model(s) to generate natural language descriptions for movement patterns of individuals 1420 and 1422 from the video of individuals 1420 and 1422.

For example, in certain implementations collaborative deterrence system 1100 may utilize one or more VLMs to generate detailed natural language descriptions of individuals 1420 and 1422 and their movement patterns. Such visual and motion cues in the form of generated natural language descriptions may then be shared among vehicles 1410-1416 during a time period t₂.

In some implementations, collaborative deterrence system 1100 can also generate natural language descriptions for speech (e.g., a conversation between individuals 1420 and 1422) and non-speech-related activity (e.g., audio of one of the individuals attempting to saw off a catalytic converter from one of vehicles 1410-1416) of individuals 1420 and 1422 based on the recorded audio of individuals 1420 and 1422. In some implementations, this may comprise utilizing an NPL or other AI model.

Accordingly, these audio cues in the form of natural language descriptions may be integrated with the above-described visual and motion cues, and shared among vehicles 1410-1416 at the time period t₂.

As described above, collaborative deterrence system 1100 (which again, may be implemented across one or more of vehicles 1410-1416) can utilize the above-described cues to determine individuals 1420 and 1422 are acting suspiciously in relation to vehicles 1410-1416. For example (and as described above), collaborative deterrence system 1100 may reason that the two individuals are systematically checking vehicles one by one and inspecting their interiors. Collaborative deterrence system 1100 may further infer that the individuals are coordinating their actions using a whistle as a signal whenever someone else appears in the vicinity.

Based on the inferences/reasoning above, along with resource and capability profiles for vehicles 1410-1416, collaborative deterrence system 1100 can determine a collaborative strategy for deterring the suspicious activity.

In the specific example of FIG. 14, this may involve checking a lookup table (or a similar structured format for storing data). Each entry of the lookup table may correspond with at least one of: (i) the inference/reasoning of collaborative deterrence system 1100 that forms a basis for determining individuals 1420 and 1422 are acting suspiciously; or (ii) the resource and capability profiles of vehicles 1410-1416.

In the specific example of FIG. 14, the collaborative deterrence strategy selected from the lookup table may involve displaying individual 1422's activity on a display of vehicle 1412 and replaying individual 1420's recorded audio through a speaker of vehicle 1416. This first example collaborative deterrence strategy may instill a belief in the suspicious individuals that they have been tracked from the beginning, signaling that all vehicles in the vicinity are aware of their actions, thereby enhancing the deterrent effect.

As depicted, during a time period t₃, collaborative deterrence system 1100 can orchestrate/control vehicles 1412 and 1416 to perform their respective assigned sub-tasks of the first example collaborative deterrence strategy.

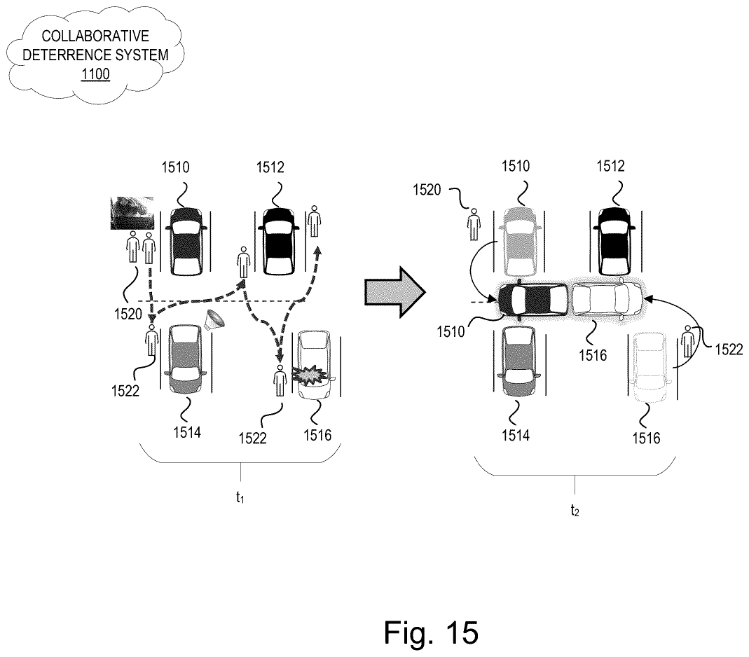

FIG. 15 depicts a second example collaborative deterrence strategy, in accordance with various embodiments of the presently disclosed technology.

As depicted, collaborative deterrence system 1100 may perform/facilitate the second example collaborative deterrence strategy. In some implementations, collaborative deterrence system 1100 may be implemented across one or more of vehicles 1510, 1512, 1514, and 1516.

As depicted, during a time period t₁, vehicles 1510 and 1514 may record activities of individuals 1520 and 1522 in relation to vehicles 1510-1516. This may be performed in the same/similar manner as described in conjunction with FIG. 14.

Collaborative deterrence system 1100 can then analyze the recorded video and audio of individuals 1520 and 1522 to determine individuals 1520 and 1522 are acting suspiciously in relation to vehicles 1510-1516 (e.g., planning to, or in the process of, vandalizing or stealing from vehicles 1510-1516). This may be performed in the same/similar manner as described in conjunction with FIG. 14.

In the specific example of FIG. 15, collaborative deterrence system 1100 may check a lookup table and not find a pre-defined collaborative deterrence strategy that corresponds to the scenario of FIG. 15. As described above, such a scenario may be defined based on at least one of: (1) the reasoning/inferences made by collaborative deterrence system 1100 that form a basis for the determination that individuals 1520 and 1522 are acting suspiciously; or (2) resource and capability profiles of vehicles 1510-1516.

In the absence of a pre-defined collaborative deterrence strategy, collaborative deterrence system 1100 can use an AI or machine learning (ML) model to analyze the resource and capability profiles of vehicles 1510-1516 to determine a new collaborative deterrence strategy. For example, collaborative deterrence system 1100 may learn/determine that vehicles 1510 and 1516 are equipped with autonomous or semi-autonomous driving systems. Based on this insight, collaborative deterrence system 1100 may use the AI/ML model to devise a group movement strategy, where vehicles 1510 and 1516 make successive autonomous maneuvers to draw the attention of individuals 1520 and 1522, as well as passers-by. The maneuvers may be executed periodically, ensuring that the deterrence effect is enhanced and continuously reinforced.

As depicted, collaborative deterrence system 1100 can orchestrate/control vehicles 1510 and 1516 to perform this second example collaborative deterrence strategy at a time period t₂.

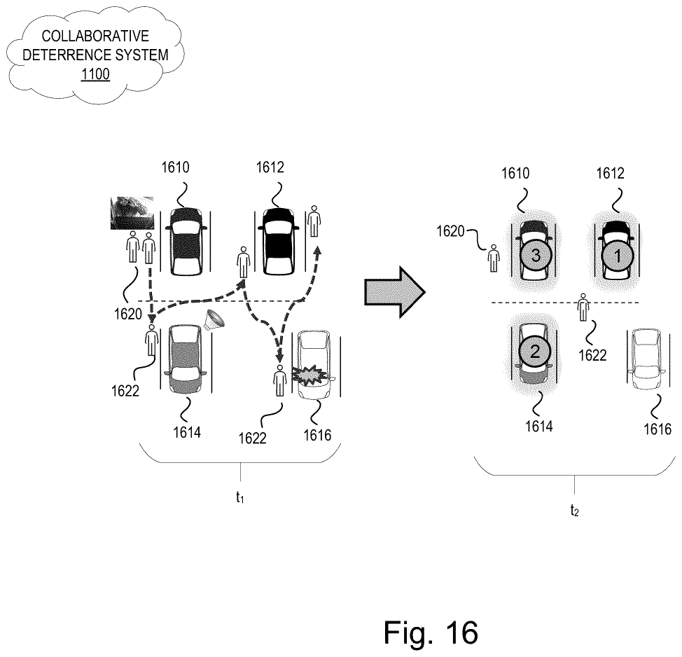

FIG. 16 depicts a third example collaborative deterrence strategy, in accordance with various embodiments of the presently disclosed technology.

As depicted, collaborative deterrence system 1100 may perform/facilitate the third example collaborative deterrence strategy. In some implementations, collaborative deterrence system 1100 may be implemented across one or more of vehicles 1610, 1612, 1614, and 1616.

As depicted, during a time period t₁, vehicles 1610 and 1614 may record activities of individuals 1620 and 1622 in relation to vehicles 1610-1616. This may be performed in the same/similar manner as described in conjunction with FIG. 14.

Collaborative deterrence system 1100 can then analyze the recorded video and audio of individuals 1620 and 1622 to determine individuals 1620 and 1622 are acting suspiciously in relation to vehicles 1610-1616 (e.g., planning to, or in the process of, vandalizing or stealing from vehicles 1610-1616). This may be performed in the same/similar manner as described in conjunction with FIG. 14.

In the specific example of FIG. 16, collaborative deterrence system 1100 may check a lookup table and find a pre-defined collaborative deterrence strategy that corresponds to the scenario of FIG. 16. As described above, such a scenario may be defined based on at least one of: (1) the reasoning/inferences made by collaborative deterrence system 1100 that form a basis for the determination that individuals 1620 and 1622 are acting suspiciously; or (2) resource and capability profiles of vehicles 1610-1616.

The collaborative deterrence strategy from the lookup table may involve activating vehicle 1612's alarm early, triggered by its in-cabin sensor detecting a valuable left behind item. Simultaneously, collaborative deterrence system 1100 can successively activate the alarms of vehicles 1614 and 1610 respectively. Accordingly, there may be a cascaded sequence of alarms (i.e., the alarm of vehicle 1612 first, the alarm of vehicle 1614 second, and the alarm of vehicle 1616 third) that draws increased public attention and reinforces the deterrent effect. In some implementations, the alarms may be sequenced in the order that individual 1622 approached the vehicles. This may instill a belief in the suspicious individuals that they have been tracked from the beginning, and may further disorient/deter the suspicious individuals.

As depicted, collaborative deterrence system 1100 can orchestrate/control vehicles 1612, 1614, and 1610 to perform this third example collaborative deterrence strategy at a time period t₂.

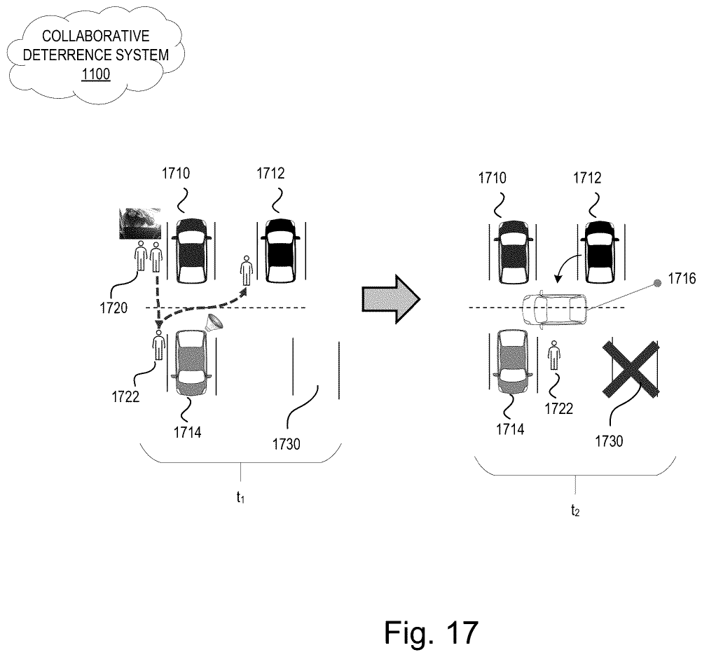

FIG. 17 depicts a fourth example collaborative deterrence strategy, in accordance with various embodiments of the presently disclosed technology.

As depicted, collaborative deterrence system 1100 may perform/facilitate the fourth example collaborative deterrence strategy. In some implementations, collaborative deterrence system 1100 may be implemented across one or more of vehicles 1710, 1712, 1714, and 1716.

As depicted, during a time period t₁, vehicles 1710 and 1714 may record activities of individuals 1720 and 1722 in relation to vehicles 1710-1714. This may be performed in the same/similar manner as described in conjunction with FIG. 14.

Collaborative deterrence system 1100 can then analyze the recorded video and audio of individuals 1720 and 1722 to determine individuals 1720 and 1722 are acting suspiciously in relation to vehicles 1710-1716 (e.g., planning to, or in the process of, vandalizing or stealing from vehicles 1710-1716). This may be performed in the same/similar manner as described in conjunction with FIG. 14.

In the specific example of FIG. 17, collaborative deterrence system 1100 may determine a collaborative deterrence strategy that involves one or more of vehicles 1710-1714 sending a warning notification to a vehicle looking to park in empty space 1730 (e.g., vehicle 1716).

For example, at a time period t₂, collaborative deterrence system 1100 can orchestrate/control vehicle 1712 to send a warning notification to vehicle 1716 when vehicle 1712 detects/predicts that vehicle 1716 is beginning to park in empty space 1730. In various implementations, the warning notification may be displayed on a graphical user interface of vehicle 1716. In certain implementations, the warning notification may be sent to an autonomous driving system implemented in vehicle 1716.

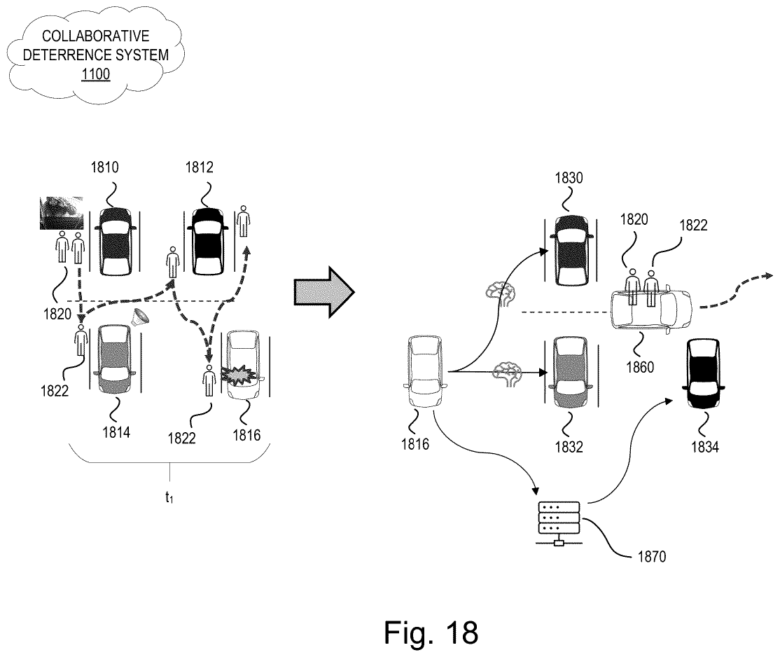

FIG. 18 depicts a fifth example collaborative deterrence strategy, in accordance with various embodiments of the presently disclosed technology.

As depicted, collaborative deterrence system 1100 may perform/facilitate the fifth example collaborative deterrence strategy. In some implementations, collaborative deterrence system 1100 may be implemented across one or more of vehicles 1810, 1812, 1814, 1816, 1830, 1832 and 1834.

As depicted, during a time period t₁, vehicles 1810 and 1814 may record activities of individuals 1820 and 1822 in relation to vehicles 1810-1814. This may be performed in the same/similar manner as described in conjunction with FIG. 14.

Collaborative deterrence system 1100 can then analyze the recorded video and audio of individuals 1820 and 1822 to determine individuals 1820 and 1822 are acting suspiciously in relation to vehicles 1810-1816 (e.g., planning to, or in the process of, vandalizing or stealing from vehicles 1810-1816). This may be performed in the same/similar manner as described in conjunction with FIG. 14.

In the specific example of FIG. 18, collaborative deterrence system 1100 can determine a collaborative deterrence strategy that involves tracking/monitoring individuals 1820 and 1822 as they attempt to flee in vehicle 1860.

For example, collaborative deterrence system 1100 can infer that the suspicious individuals are using vehicle 1860 to flee the scene. Collaborative deterrence system 1100 (including the vehicles it is implemented across) can identify vehicle 1860 through its inferred feature set/unique characteristics. Accordingly, nearby vehicles can be notified about vehicle 1860 and its feature set/unique characteristics. For example, collaborative deterrence system 1100 can initiate a tracking request for vehicle 1860. In response to this tracking request, at time period t₂, vehicle 1816 may transfer its knowledge regarding vehicle 1860 to one or more of vehicle 1830, vehicle 1832, and law enforcement server 1870. Law enforcement server 1870 may then transfer this knowledge to vehicle 1834. As depicted, collaborative deterrence system 1100/vehicle 1816 can intelligently transfer knowledge to these vehicles based on a prediction of vehicle 1860's navigation route (e.g., a navigation route that passes proximate vehicles 1830, 1832 and 1834).

Thus, in accordance with this fifth example collaborative deterrence strategy, collaborative deterrence system 1100 can accumulate inferred features from suspicious individuals and their vehicles, enabling coordinated tracking across multiple vehicles. These vehicles can monitor and record the movement of the suspicious individuals, including routes taken and directions traveled. This real-time information can be shared with law enforcement, enhancing their ability to respond effectively.

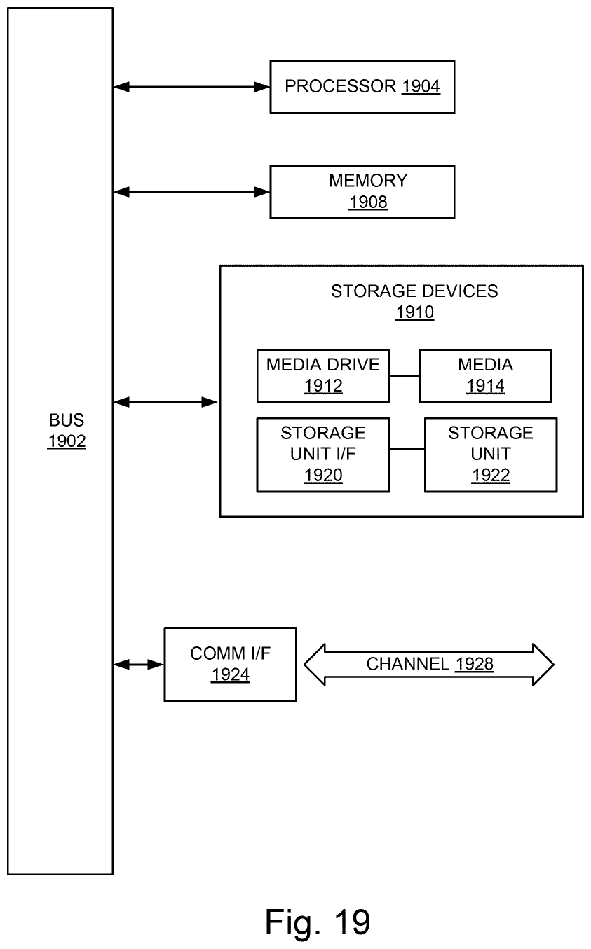

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 19. Various embodiments are described in terms of this example-computing component 1100. After reading this description, it will become apparent to a person skilled in the relevant art how to implement the application using other computing components or architectures.

Referring now to FIG. 19, computing component 1900 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1900 might also represent computing capabilities embedded within or otherwise available to a given device. For example, a computing component might be found in other electronic devices such as, for example, portable computing devices, and other electronic devices that might include some form of processing capability.

Computing component 1900 might include, for example, one or more processors, controllers, control components, or other processing devices. This can include a processor, and/or any one or more of the components. Processor 1904 might be implemented using a general-purpose or special-purpose processing engine such as, for example, a microprocessor, controller, or other control logic. Processor 1904 may be connected to a bus 1902. However, any communication medium can be used to facilitate interaction with other components of computing component 1900 or to communicate externally.

Computing component 1900 might also include one or more memory components, simply referred to herein as main memory 1908. For example, random access memory (RAM) or other dynamic memory, might be used for storing information and instructions to be executed by processor 1904. Main memory 1908 might also be used for storing temporary variables or other intermediate information during execution of instructions to be executed by processor 1904. Computing component 1900 might likewise include a read only memory (“ROM”) or other static storage device coupled to bus 1902 for storing static information and instructions for processor 1904.

The computing component 1900 might also include one or more various forms of information storage mechanism 1190, which might include, for example, a media drive 1912 and a storage unit interface 1920. The media drive 1912 might include a drive or other mechanism to support fixed or removable storage media 1914. For example, a hard disk drive, a solid-state drive, a magnetic tape drive, an optical drive, a compact disc (CD) or digital video disc (DVD) drive (R or RW), or other removable or fixed media drive might be provided. Storage media 1914 might include, for example, a hard disk, an integrated circuit assembly, magnetic tape, cartridge, optical disk, a CD or DVD. Storage media 1914 may be any other fixed or removable medium that is read by, written to or accessed by media drive 1912. As these examples illustrate, the storage media 1914 can include a computer usable storage medium having stored therein computer software or data.

In alternative embodiments, information storage mechanism 1190 might include other similar instrumentalities for allowing computer programs or other instructions or data to be loaded into computing component 1900. Such instrumentalities might include, for example, a fixed or removable storage unit 1922 and an interface 1920. Examples of such storage units 1922 and interfaces 1920 can include a program cartridge and cartridge interface, a removable memory (for example, a flash memory or other removable memory component) and memory slot. Other examples may include a PCMCIA slot and card, and other fixed or removable storage units 1922 and interfaces 1920 that allow software and data to be transferred from storage unit 1922 to computing component 1900.

Computing component 1900 might also include a communications interface 1924. Communications interface 1924 might be used to allow software and data to be transferred between computing component 1900 and external devices. Examples of communications interface 1924 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 1924 may be carried on signals, which can be electronic, electromagnetic (which includes optical) or other signals capable of being exchanged by a given communications interface 1924. These signals might be provided to communications interface 1924 via a channel 1928. Channel 1928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1908, storage unit 1920, media 1914, and channel 1928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1900 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Reference to A “and” B may be construed to also encompass the scenario of A “or” B. Reference to A “or” B may be construed to also encompass the scenario of A “and” B. Any reference to a “threshold” or “sufficiency” may be construed to encompass any applicable value or degree. For example, a threshold level, similarity or degree thereof may be construed to include any values such as 99 percent, 98 percent, 95 percent, 90 percent, 80 percent, 75 percent, or any other value therebetween, or any ranges therebetween. Additionally or alternatively, a threshold similarity or degree may be construed as qualitatively satisfying some condition, such as presence of one or more common features. Any reference to sufficiently similar may also be construed to encompass same or similar meanings as satisfying a threshold.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
responsive to detecting suspicious activity being perpetrated by one or more individuals in relation to vehicles, determining a collaborative strategy to deter the suspicious activity;
assigning sub-tasks of the collaborative deterrence strategy to a group of the vehicles based on resource and capability profiles of the group of vehicles; and
controlling at least one of the group of vehicles to perform its assigned sub-task of the collaborative deterrence strategy.

2. The method of claim 1, wherein the assigning is based on at least one of:
differences in sensor resources across the group of vehicles;
differences in processing resources across the group of vehicles;
differences in wireless communication resources across the group of vehicles;
differences in audio-visual output capabilities across the group of vehicles; or
differences in autonomous driving capabilities across the group of vehicles.

3. The method of claim 2, wherein the group of vehicles comprises at least a first vehicle and a second vehicle and assigning the sub-tasks of the collaborative deterrence strategy to the first and second vehicles comprises:
determining the first vehicle has superior processing resources to the second vehicle;
assigning the first vehicle to further analyze the activity of the one or more individuals in relation to the vehicles; and
assigning the second vehicle to perform a less processor-intensive sub-task of the collaborative deterrence strategy.

4. The method of claim 2, wherein the group of vehicles comprises at least a first vehicle and a second vehicle and assigning the sub-tasks of the collaborative deterrence strategy to the first and second vehicles comprises:
determining the first vehicle has superior audio output capabilities to the second vehicle;
assigning the first vehicle to output an audio-based deterrence action; and
assigning the second vehicle to perform a non-audio output-related sub-task of the collaborative deterrence strategy.

5. The method of claim 2, wherein the group of vehicles comprises at least a first vehicle and a second vehicle and assigning the sub-tasks of the collaborative deterrence strategy to the first and second vehicles comprises:
determining the first vehicle has a superior visual display to the second vehicle;
assigning the first vehicle to display video of the one or more individuals on its superior visual display; and
assigning the second vehicle to perform a non-visual output-related sub-task of the collaborative deterrence strategy.

6. The method of claim 2, wherein the group of vehicles comprises at least a first vehicle and a second vehicle and assigning the sub-tasks of the collaborative deterrence strategy to the first and second vehicles comprises:
determining the first vehicle has superior autonomous driving capabilities to the second vehicle;
assigning the first vehicle to move autonomously to deter the suspicious activity; and
assigning the second vehicle to perform a non-autonomous driving-related sub-task of the collaborative deterrence strategy.

7. The method of claim 1, wherein the assigning is further based on positional relationships between the one or more individuals and respective vehicles of the group of vehicles.

8. The method of claim 7, wherein the group of vehicles comprises at least a first vehicle and a second vehicle and assigning the sub-tasks of the collaborative deterrence strategy to the first and second vehicles comprises:
determining that at least one of the one or more individuals is gazing into the first vehicle;
assigning the first vehicle to display video of the one or more individuals on a visual display within the first vehicle; and
assigning the second vehicle to perform a non-visual output-related sub-task of the collaborative deterrence strategy.

9. The method of claim 1, further comprising, responsive to detecting the suspicious activity being perpetrated by the one or more individuals in relation to the vehicles:
determining a collaborative strategy to monitor the suspicious activity; and
assigning sub-tasks of the collaborative monitoring strategy to the group of vehicles based on:
the resource and capability profiles of the group of vehicles, and
positional relationships between the one or more individuals and respective vehicles of the group of vehicles.

10. The method of claim 9, wherein assigning the sub-tasks of the collaborative monitoring strategy is based on at least one of:
differences in audio-recording resources and audio-recording capabilities across the group of vehicles;
differences in video-recording resources and video-recording capabilities across the group of vehicles; or
differences in motion tracking resources and motion tracking capabilities across the group of vehicles.

11. The method of claim 1, wherein detecting the suspicious activity being perpetrated by the one or more individuals in relation to the vehicles comprises:
obtaining video of the one or more individuals;
generating, from the video, natural language descriptions for physical characteristics of the one or more individuals and movement characteristics of the one or more individuals relative to the vehicles; and
providing the generated natural language descriptions to a natural language processing (NPL) model and using the NPL model to determine the one or more individuals are acting suspiciously in relation to the vehicles.

12. A system comprising:
one or more processors; and
memory storing machine-readable instructions that, when executed by the one or more processors, cause the system to:
responsive to detecting suspicious activity being perpetrated by an individual in relation to vehicles, determine a collaborative strategy to deter the suspicious activity;
assign sub-tasks of the collaborative deterrence strategy to a group of the vehicles based on at least one of:
resource and capability profiles of the group of vehicles, or positional relationships between the individual and respective vehicles of the group of vehicles, and
control at least one of the group of vehicles to perform its assigned sub-task of the collaborative deterrence strategy.

13. The system of claim 12, wherein the assigning based on the positional relationships between the individual and the respective vehicles is based on detected location and attentional direction of the individual with respect to the respective vehicles.

14. The system of claim 13, wherein the group of vehicles comprises at least a first vehicle and a second vehicle and assigning the sub-tasks of the collaborative deterrence strategy to the first and second vehicles comprises:
determining the individual is gazing into the first vehicle;
assigning the first vehicle to display video of the individual on a visual display within the first vehicle; and
assigning the second vehicle to perform a non-visual output-related sub-task of the collaborative deterrence strategy.

15. The system of claim 12, wherein the assigning based on the resource and capability profiles of the group of vehicles is based on at least one of:
differences in sensor resources across the group of vehicles;
differences in processing resources across the group of vehicles;
differences in wireless communication resources across the group of vehicles;
differences in audio-visual output capabilities across the group of vehicles; or
differences in autonomous driving capabilities across the group of vehicles.

16. The system of claim 15, wherein the group of vehicles comprises at least a first vehicle and a second vehicle and assigning the sub-tasks of the collaborative deterrence strategy to the first and second vehicles comprises:
determining the first vehicle has superior processing resources to the second vehicle;
assigning the first vehicle to further analyze the activity of the individual in relation to the vehicles; and
assigning the second vehicle to perform a less processor-intensive sub-task of the collaborative deterrence strategy.

17. The system of claim 15, wherein the group of vehicles comprises at least a first vehicle and a second vehicle and assigning the sub-tasks of the collaborative deterrence strategy to the first and second vehicles comprises:
determining the first vehicle has superior audio output capabilities to the second vehicle;
assigning the first vehicle to output an audio-based deterrence action; and
assigning the second vehicle to perform a non-audio output-related sub-task of the collaborative deterrence strategy.

18. The system of claim 15, wherein the group of vehicles comprises at least a first vehicle and a second vehicle and assigning the sub-tasks of the collaborative deterrence strategy to the first and second vehicles comprises:
determining the first vehicle has a superior visual display to the second vehicle;
assigning the first vehicle to display video of the individual on its superior visual display; and
assigning the second vehicle to perform a non-visual output-related sub-task of the collaborative deterrence strategy.

19. The system of claim 15, wherein the group of vehicles comprises at least a first vehicle and a second vehicle and assigning the sub-tasks of the collaborative deterrence strategy to the first and second vehicles comprises:
determining the first vehicle has superior autonomous driving capabilities to the second vehicle;
assigning the first vehicle to move autonomously to deter the suspicious activity; and
assigning the second vehicle to perform a non-autonomous driving-related sub-task of the collaborative deterrence strategy.

20. A method comprising:
responsive detecting suspicious activity being perpetrated by an individual in relation to vehicles, determining a collaborative strategy to deter the suspicious activity;
assigning sub-tasks of the collaborative deterrence strategy to a group of the vehicles based on at least one of:
resource and capability profiles of the group of vehicles, or
positional relationships between the individual and respective vehicles of the group of vehicles, and
controlling at least one of the group of vehicles to perform its assigned sub-task of the collaborative deterrence strategy.
